(19) United States
(12) Patent Application Publication
(10) Pub. No.: US 2025/0005912 A1
(43) Pub. Date: Jan. 2, 2025

(54) DETECTING FACE MORPHING BY ONE-TO-MANY FACE RECOGNITION

(71) Applicant: Government of the United States of America, as represented by the Secretary of Commerce, Gaithersburg, MD (US)

(72) Inventors: Mei Lee Ngan, Clarksburg, MD (US); Patrick Joseph Grother, Washington, DC (US); Kayee Kwong Hanaoka, Silver Spring, MD (US)

(21) Appl. No.: 18/709,705

(22) PCT Filed: Mar. 13, 2023
(86) PCT No.: PCT/US2023/015079

§ 371 Date: May 13, 2024

Related U.S. Application Data
(60) Provisional application No. 63/392,741, filed on Jul. 27, 2022.

(51) Int. Cl. G06V 10/776; G06F 16/532; G06V 10/74; G06V 10/82; G06V 40/16

(52) U.S. Cl. CPC G06V 10/776; G06F 16/532; G06V 10/761; G06V 40/172; G06V 10/82

(57) ABSTRACT

A process and system for detecting face morphing by one-to-many face recognition includes: obtaining, by at least one processor of a computing device a probe image; performing a probe one-to-many search for the probe image among a gallery; producing a probe candidate list including a plurality of probe similarity scores; comparing the highest probe similarity scores of the probe candidate list to a morph decision boundary; and determining whether the probe image is a bona fide face image or a morph face image as a result of comparing the highest probe similarity scores to detect face morphing.

### CROSS REFERENCE TO RELATED APPLICATIONS

This application claims the benefit of U.S. Provisional Patent Application Ser. No. 63/392,741 (filed Jul. 27, 2022), which is herein incorporated by reference in its entirety.

### STATEMENT REGARDING FEDERALLY SPONSORED RESEARCH

This invention was made with United States Government support from the National Institute of Standards and Technology (NIST), an agency of the United States Department of Commerce. The Government has certain rights in this invention.

### BRIEF DESCRIPTION

Disclosed is a process implemented by one or more processors for detecting face morphing by one-to-many face recognition, the process comprising: obtaining, by at least one processor of a computing device a probe image; performing, by the at least one processor, a probe one-to-many search for the probe image among a gallery; producing, by the at least one processor, a probe candidate list from performing the probe one-to-many search for the probe image, the probe candidate list comprising a plurality of probe similarity scores; comparing, by the at least one processor, the highest probe similarity scores of the probe candidate list to a morph decision boundary; and determining, by the at least one processor, whether the probe image is a bona fide face image or a morph face image as a result of comparing the highest probe similarity scores to detect face morphing.

Embodiments can include a computer program comprising instructions that when executed by one or more processors of a computing system, cause the computing system to perform a process such as one or more of the process described above or elsewhere herein.

Embodiments include one or more computing devices configured to perform a process such as one or more of the process described above or elsewhere herein.

The above description is provided as an overview of some implementations of the present disclosure. Further description of those implementations, and other implementations, are described in more detail below.

Other implementations can include a non-transitory computer readable storage medium storing instructions executable by one or more processors (e.g., central processing unit(s) (CPU(s)), graphics processing unit(s) (GPU(s)), and/or tensor processing unit(s) (TPU(s)) to perform a process such as one or more of the process described above or elsewhere herein. Yet other implementations can include a system of one or more computers that include one or more processors operable to execute stored instructions to perform a process such as one or more of the process described above or elsewhere herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1 shows detecting face morphing by one-to-many face recognition, according to some embodiments.

FIG. 2 shows producing morph face images 206, according to some embodiments.

FIG. 3 shows validating morph face images 206, according to some embodiments.

FIG. 4 shows a one-to-many search, according to some embodiments.

FIG. 5 shows obtaining highest similarity scores from a candidate list, according to some embodiments.

FIG. 6 shows aspects of training a neural network for detecting morph face images, according to some embodiments, wherein a neural network architecture for training a morph classifier with 1:N algorithm rank 1 and 2 scores for which a sigmoid function used in the hidden and output layers.

FIG. 7 shows a computing device that can be included in a system for detecting face morphing by one-to-many face recognition, according to some embodiments.

FIG. 8 shows detecting face morphing by one-to-many face recognition, according to some embodiments.

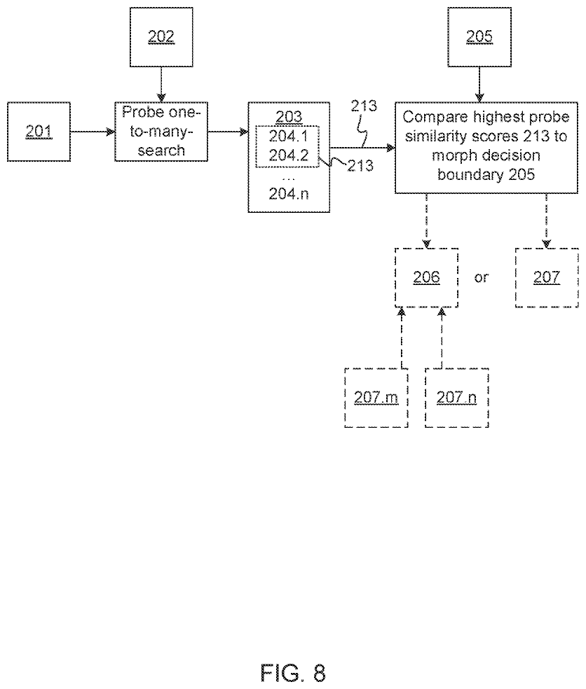

FIG. 9 shows a graph for face recognition algorithm vulnerability on morphs against general algorithm accuracy on non-morphed photos. Each point represents a face recognition algorithm submitted to NIST FRVT 1:1 activity. The y-axis is MMPMR, which is the fraction of morphs where both subjects incorrectly match to the morph. The x-axis is FNMR or miss rate on regular photos, which provides an indication of general algorithm accuracy. MMPMR and FNMR are calculated with thresholds set to a false-match rate (FMR) of 0.0001. The morphs were generated with two people with equal contribution from each subject, according to some embodiments.

FIG. 10 shows exemplar portrait images, according to some embodiments.

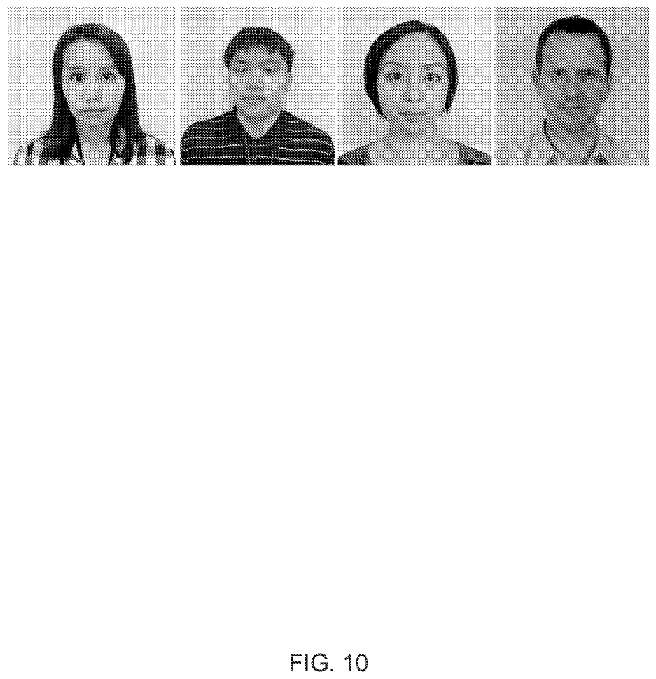

FIG. 11 shows morph face image generated with UNIBO's v2.0 morphing tool, according to some embodiments.

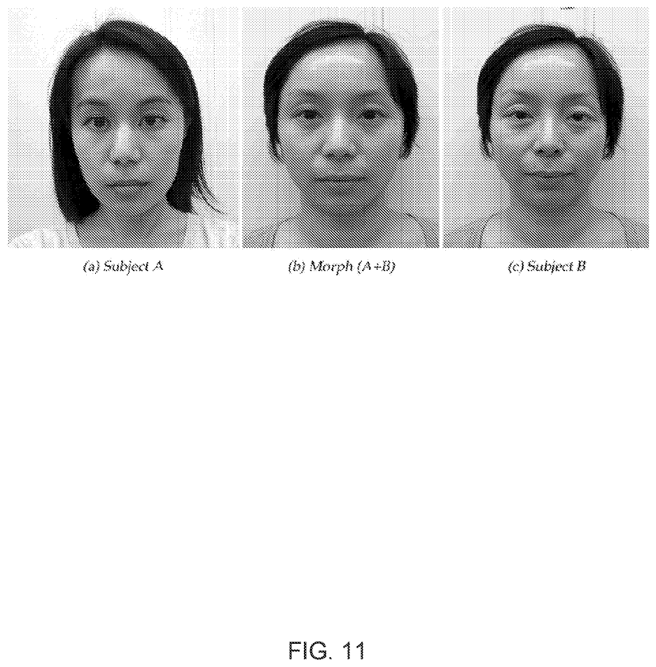

FIG. 12 shows similarity scores that are returned on a candidate list for a mated search against a consolidated gallery based on the type of probe (bona fide or morph) and the subject(s) in the database, according to some embodiments.

FIG. 13 shows graphs of rank 1 score versus rank 2 score, wherein the position of each point in individual scatter plots represents the native rank 1 and 2 similarity scores for bona fide or morph probes searched against a consolidated gallery that contains a prior photo of the subject(s). For bona fides, the probes are broken out by the age difference between the probe and the gallery image (<5 years and 5-10 years). For morphs, scores are shown for galleries that include either one subject or both subjects that went into the morph. All galleries contain 1.6 million unique people.

FIG. 14 shows a graph for rank 1 scores and rank 2 scores from bona fide and morph search scenarios against a consolidated gallery from FIG. 13, according to some embodiments.

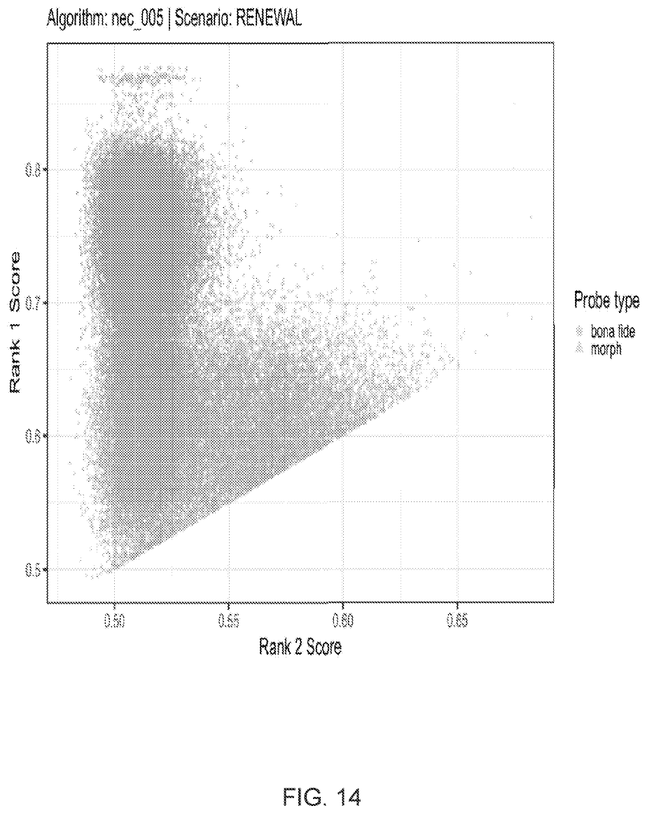

FIG. 15 shows an accuracy of morph classifiers trained on different 1:N algorithm rank 1 and rank 2 scores for morphed searches (one or both subjects in gallery) and mated bona fide searches against a consolidated gallery, according to some embodiments.

FIG. 16 shows similarity scores that are returned on a candidate list for a mated search against an unconsolidated gallery where two or more images of each subject exist in the gallery. Examples show possible candidate list outcomes based on the type of probe (bona fide or morph) and the subject(s) in the database, according to some embodiments.

FIG. 17 shows graphs of rank 1 scores versus rank 2 scores, wherein the position of each point in the scatter plot represents the native rank 1 and rank 2 similarity scores for bona fide or morph probes searched against an unconsolidated gallery that contains two or more prior photos of the subject(s), according to some embodiments. For bona fides, the probes are broken out by the age difference between the probe and the gallery images (<5 years and 5-10 years). For morphs, scores are shown for galleries that include either one subject or both subjects that went into the morph. All galleries contain one or more photos of 1.6 million unique people.

FIG. 18 shows a graph for rank 1 and rank 2 scores from bona fide and morph search scenarios against an unconsolidated gallery from FIG. 17, according to some embodiments.

FIG. 19 shows an accuracy of morph classifiers trained on different 1:N algorithm rank 1 and rank 2 scores for morphed searches (one or both subjects in gallery) and mated bona fide searches against a unconsolidated galleries, according to some embodiments.

FIG. 20 shows similarity scores that are returned on a candidate list for a non-mated search against a gallery where no images of the subject(s) exist in the gallery, wherein possible candidate list outcomes are based on the type of probe (bona fide or morph), according to some embodiments.

FIG. 21 shows native rank 1 and rank 2 similarity scores for bona fide or morph probes searched against a consolidated gallery when no prior photos of the subjects exist in the gallery, wherein all galleries contain 1.6 million unique people, according to some embodiments.

FIG. 22 shows rank 1 and rank 2 scores from the bona fide and morph search scenarios against an consolidated gallery from FIG. 21, according to some embodiments.

FIG. 23 shows accuracy of morph classifiers trained on different 1:N algorithm rank 1 and rank 2 scores for morphed or bona fide searches against a consolidated gallery when no prior photos of the subjects exist in the gallery, according to some embodiments.

FIG. 24 shows graphs for native 1:N algorithm rank 1 and rank 2 similarity scores for bona fide or morph probes searched against a consolidated gallery that contains a prior photo of the subject(s), according to some embodiments. For bona fides, scores are broken out by the time elapsed (<5 years or between 5-10 years) between the probe and gallery photo. For morphs, scores are shown for galleries that include either one subject or both subjects that went into the morph. All galleries contain 1.6 million unique people.

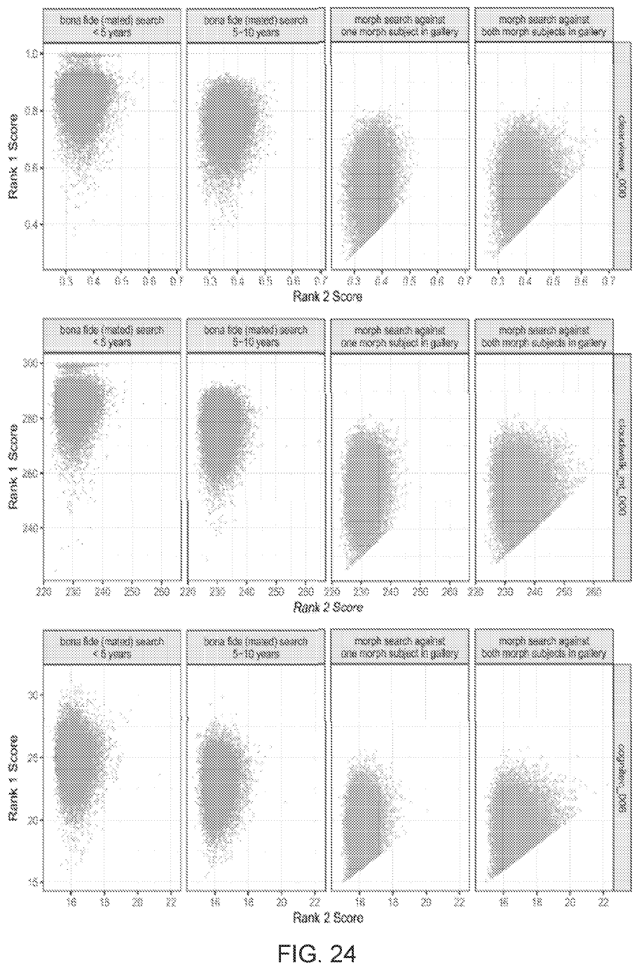

FIG. 25 shows graphs for native 1:N algorithm rank 1 and rank 2 similarity scores for bona fide or morph probes searched against a consolidated gallery that contains a prior photo of the subject(s), according to some embodiments. For bona fides, scores are broken out by the time elapsed (<5 years or between 5-10 years) between the probe and gallery photo. For morphs, scores are shown for galleries that include either one subject or both subjects that went into the morph. All galleries contain 1.6 million unique people.

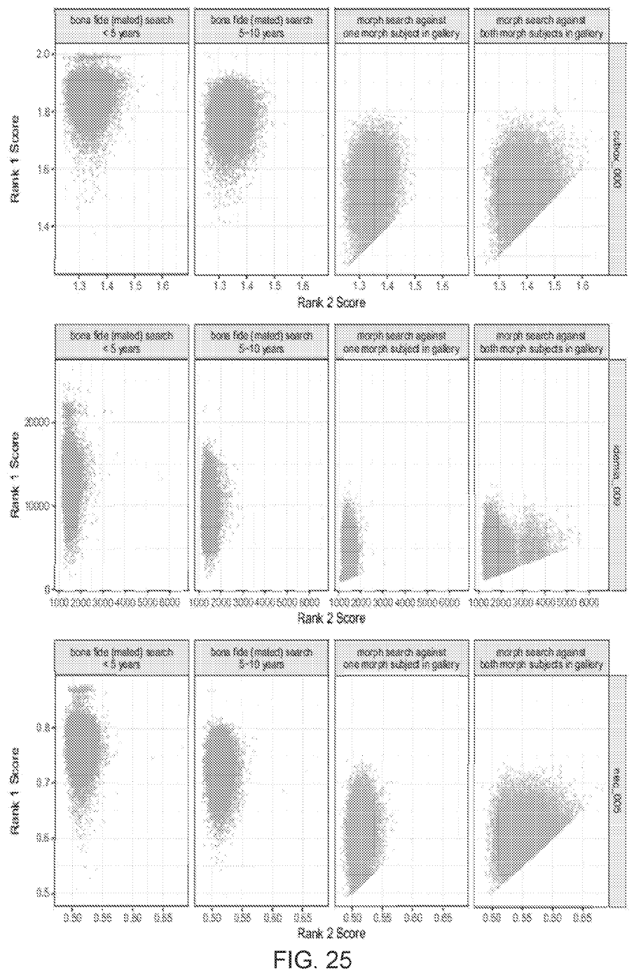

FIG. 26 shows, according to some embodiments, graphs for native 1:N algorithm rank 1 and rank 2 similarity scores for bona fide or morph probes searched against a consolidated gallery that contains a prior photo of the subject(s). For bona fides, scores are broken out by the time elapsed (<5 years or between 5-10 years) between the probe and gallery photo. For morphs, scores are shown for galleries that include either one subject or both subjects that went into the morph. All galleries contain 1.6 million unique people.

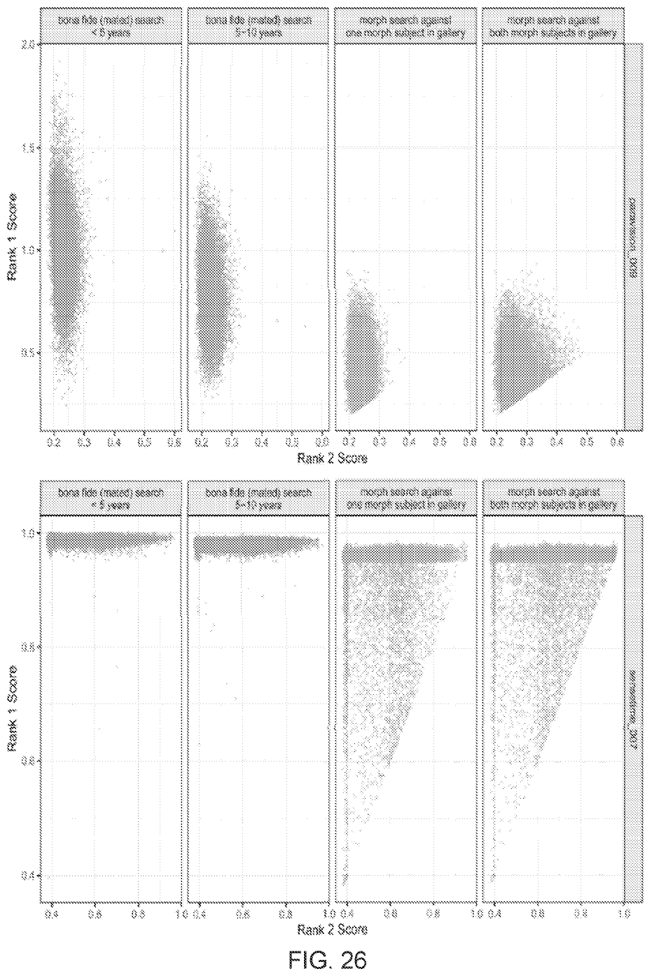

FIG. 27 shows, according to some embodiments, native 1:N algorithm rank 1 and rank 2 similarity scores for bona fide or morph probes searched against an unconsolidated gallery that contains multiple (two or more) prior photos of the subject(s). For bona fides, scores are broken out by the time elapsed (<5 years or between 5-10 years) between the probe and gallery photos. For morphs, scores are shown for galleries that include either one subject or both subjects that went into the morph. All galleries contain 1.6 million unique people.

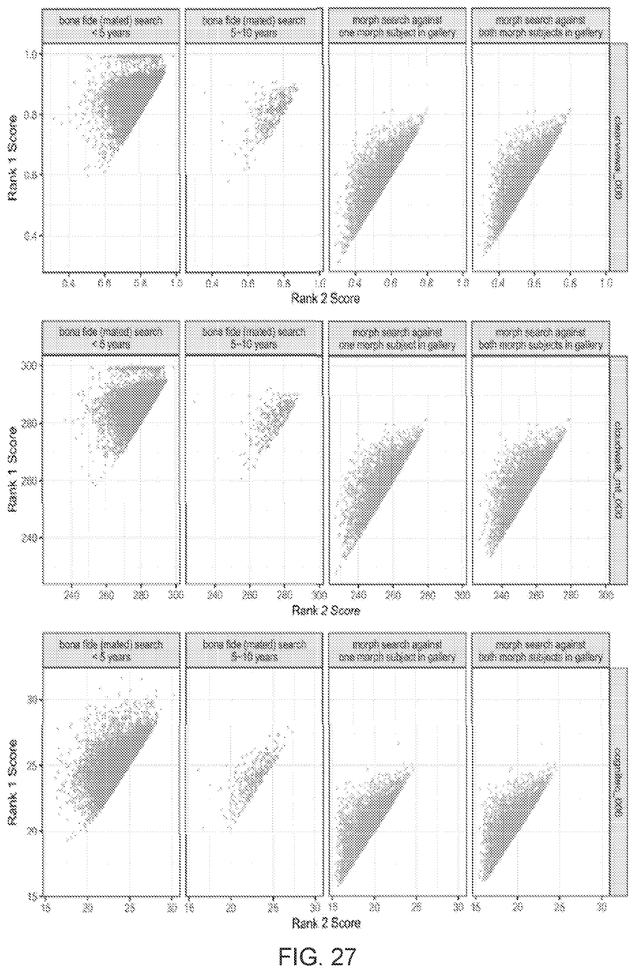

FIG. 28 shows, according to some embodiments, graphs for native 1:N algorithm rank 1 and rank 2 similarity scores for bona fide or morph probes searched against an unconsolidated gallery that contains multiple (two or more) prior photos of the subject(s). For bona fides, scores are broken out by the time elapsed (<5 years or between 5-10 years) between the probe and gallery photos. For morphs, scores are shown for galleries that include either one subject or both subjects that went into the morph. All galleries contain 1.6 million unique people.

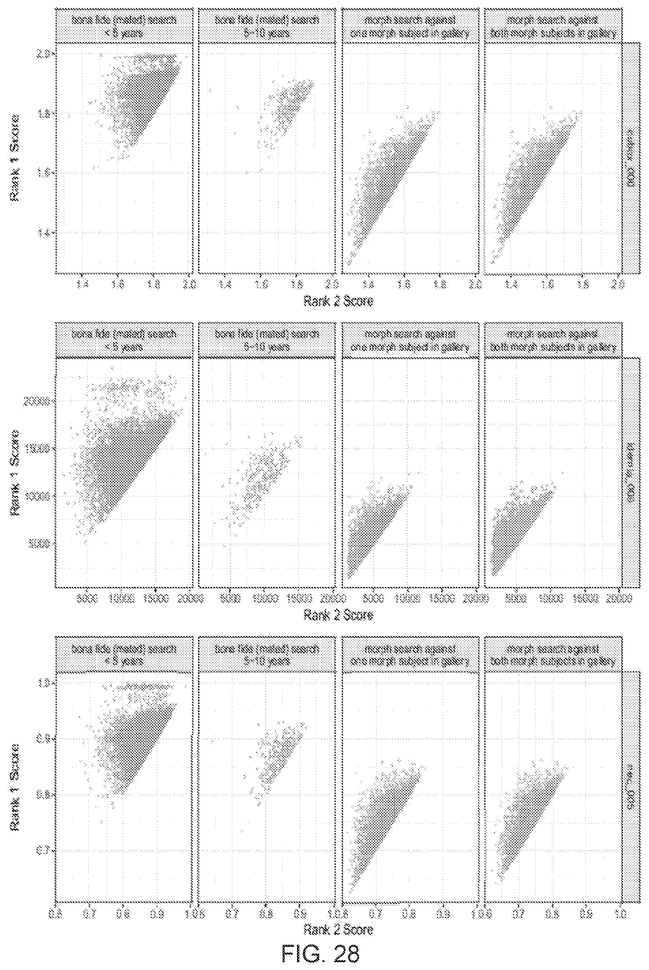

FIG. 29 shows, according to some embodiments, graphs for native 1:N algorithm rank 1 and rank 2 similarity scores for bona fide or morph probes searched against an unconsolidated gallery that contains multiple (two or more) prior photos of the subject(s). For bona fides, scores are broken out by the time elapsed (<5 years or between 5-10 years) between the probe and gallery photos. For morphs, scores are shown for galleries that include either one subject or both subjects that went into the morph. All galleries contain 1.6 million unique people.

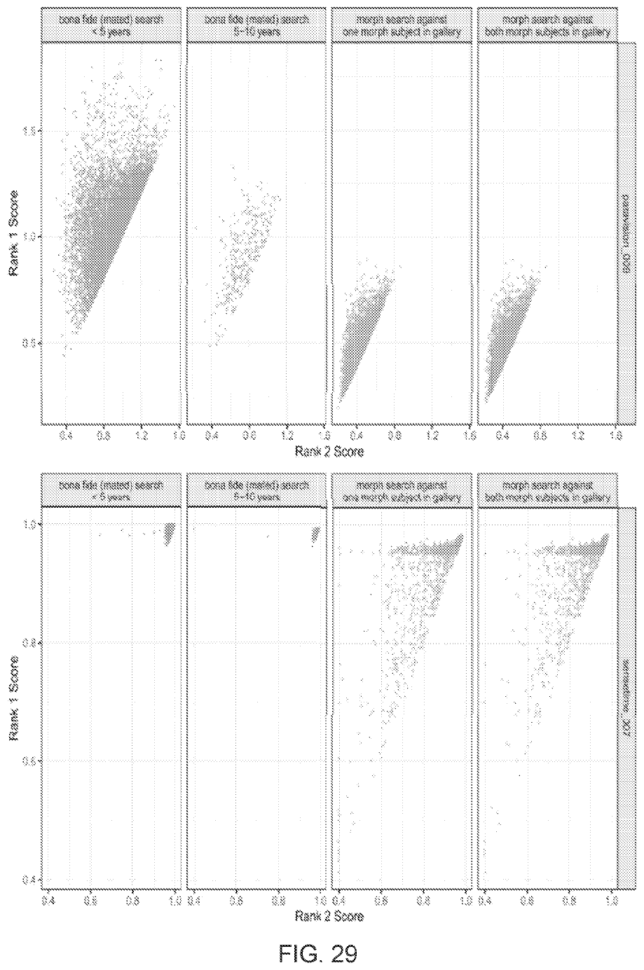

FIG. 30 shows, according to some embodiments, graphs of native rank 1 and rank 2 similarity scores for bona fide or morph probes searched against a consolidated gallery when no prior photos of the subjects exist in the gallery. All galleries contain 1.6 million unique people.

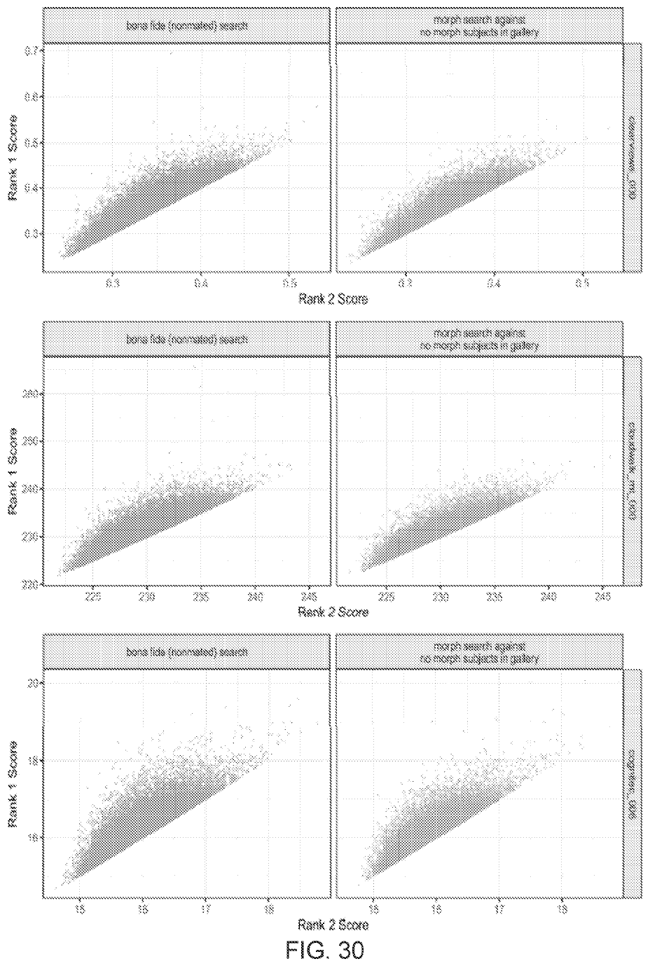

FIG. 31 shows, according to some embodiments, graphs of rank 1 and rank 2 similarity scores for bona fide or morph probes searched against a consolidated gallery when no prior photos of the subjects exist in the gallery. All galleries contain 1.6 million unique people.

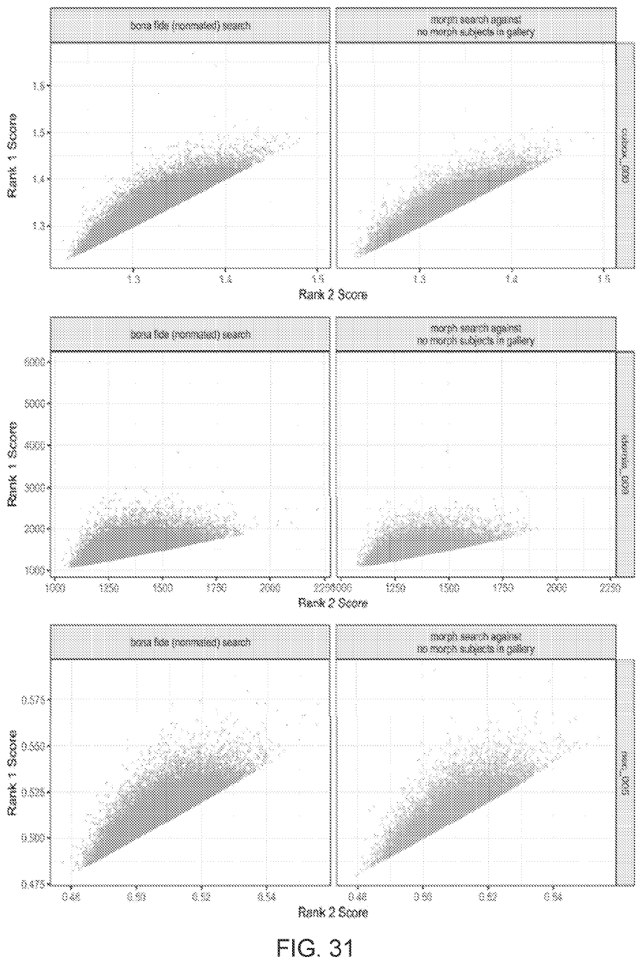

FIG. 32 shows, according to some embodiments, graphs of native rank 1 and rank 2 similarity scores for bona fide or morph probes searched against a consolidated gallery when no prior photos of the subjects exist in the gallery. All galleries contain 1.6 million unique people.

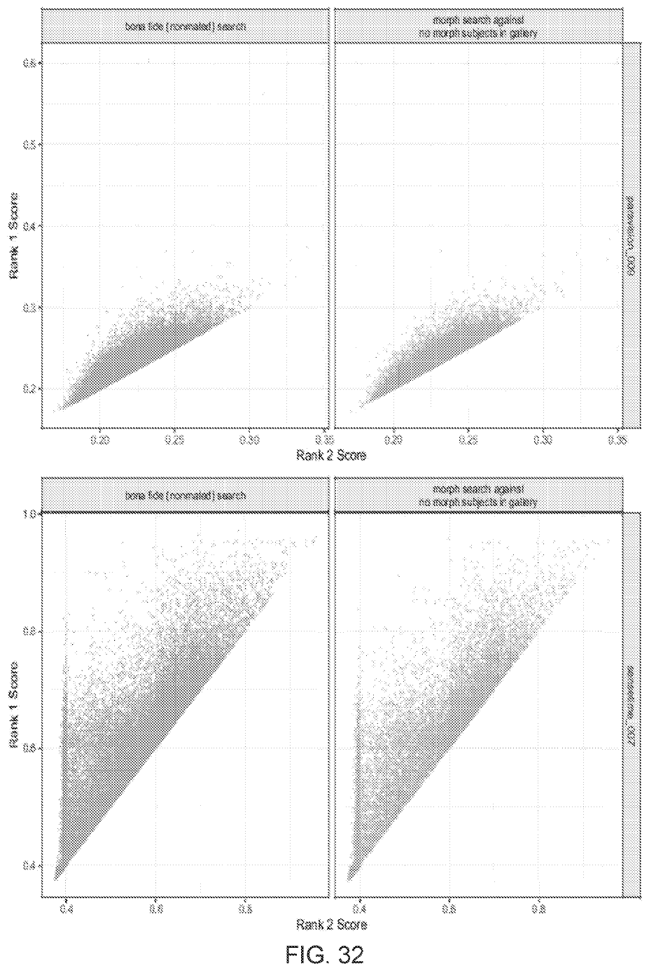

### DETAILED DESCRIPTION

A detailed description of one or more embodiments is presented herein by way of exemplification and not limitation.

Face morphing can be vulnerability to conventional automated face recognition because conventional face recognition algorithms can incorrectly match a composite image (sometimes referred to as a morph) with images of people that contributed to the morph. Conventional technology does not provide adequate morph detection capability or operate effectively at operationally-realistic false detection rates. A process for detecting face morphing by one-to-many face recognition described herein overcomes this deficiency and advantageously has a morph detection rate at a reduced false detection rate that is better than conventional morph detection.

The process for detecting face morphing by one-to-many face recognition provides detection of face morphing in an image by one-to-many face recognition. With regard to images, face morphing can include combining, e.g., blending, multiple faces to form a single face.

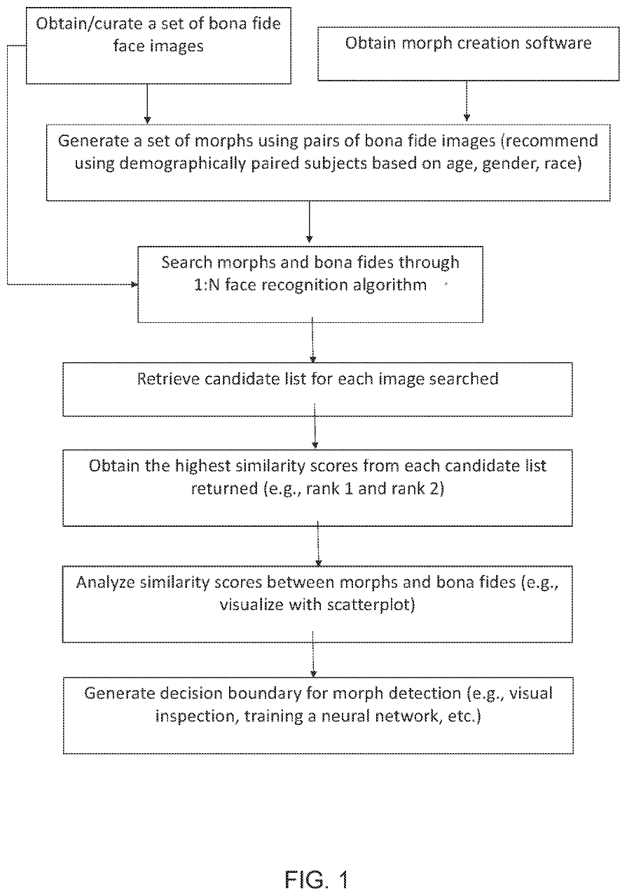

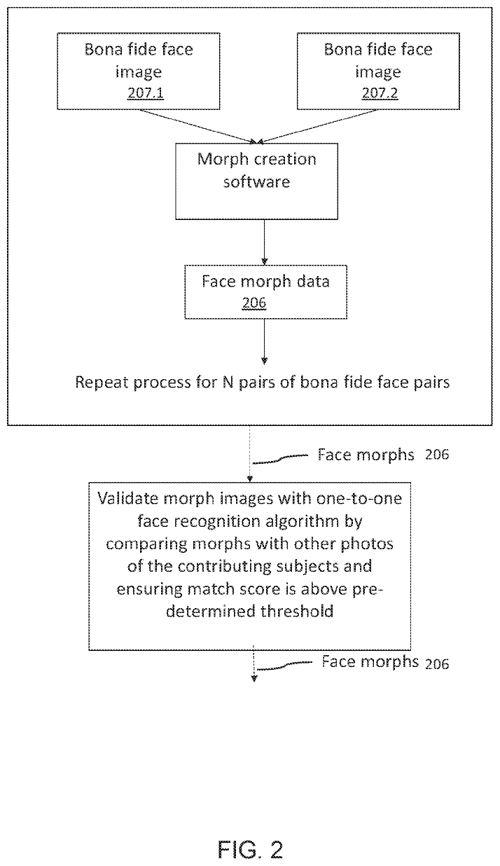

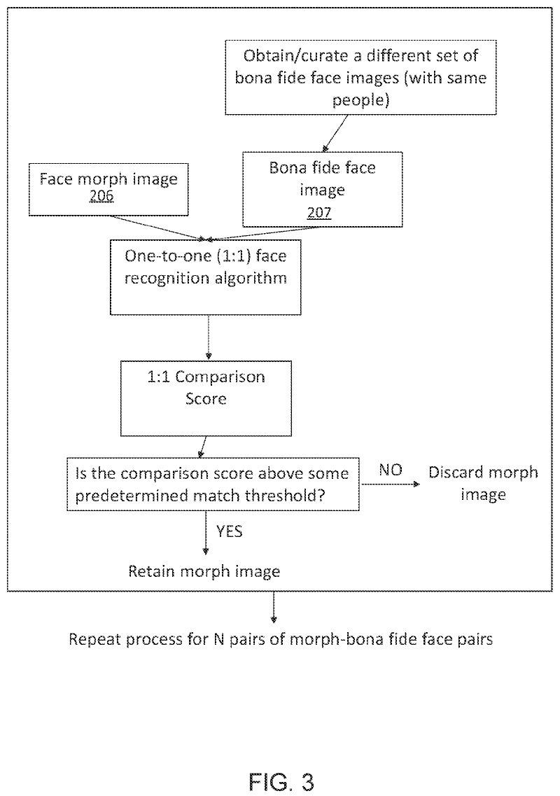

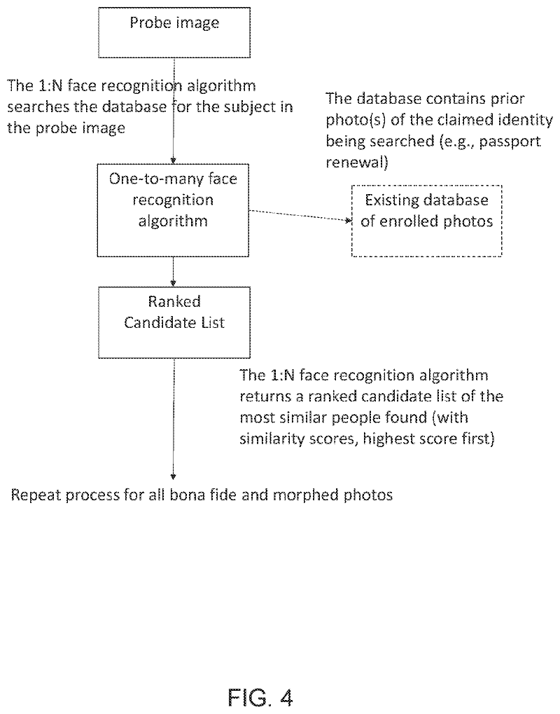

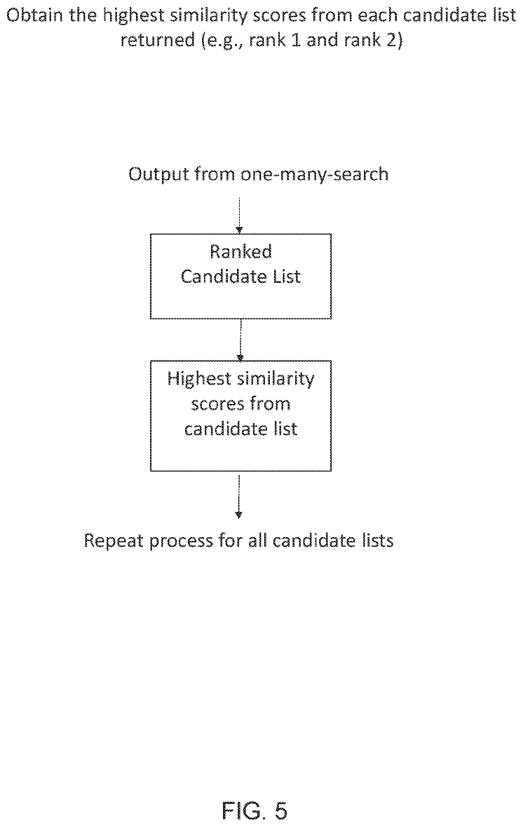

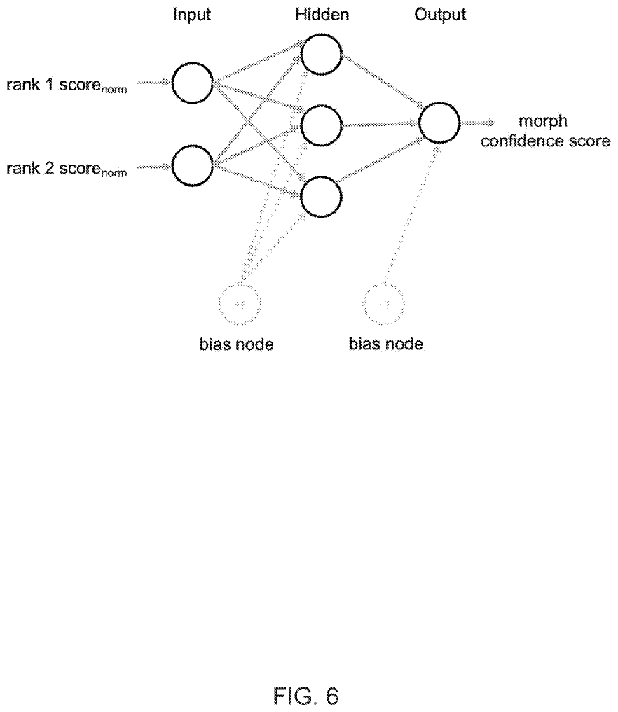

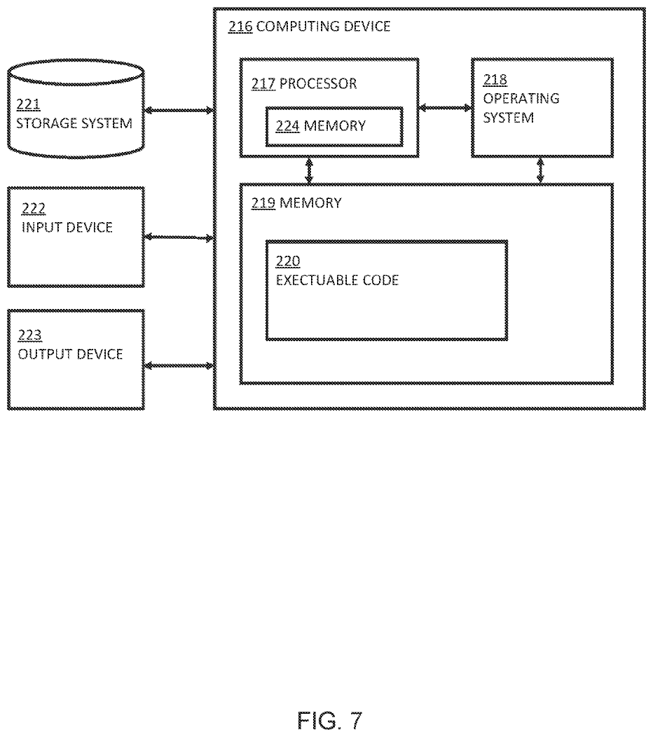

In an embodiment, with reference to FIG. 1, FIG. 2, FIG. 3, FIG. 4, FIG. 5, FIG. 6, and FIG. 7, a process implemented by one or more processors for detecting face morphing by one-to-many face recognition includes: obtaining, by at least one processor of a computing device, a probe image 201; performing, by the at least one processor, a probe one-to-many search for the probe image 201 among a gallery 202; producing, by the at least one processor, a probe candidate list 203 from performing the probe one-to-many search for the probe image 201, the probe candidate list 203 comprising a plurality of probe similarity scores 204 (e.g., 204.1, 204.2, . . . , 204.n; wherein n is an arbitrary integer representing the total number of similarity scores); comparing, by the at least one processor, the highest probe similarity scores 213 of the probe candidate list 203 to a morph decision boundary 205; and determining, by the at least one processor, whether the probe image 201 is a bona fide face image 207 or a morph face image 206 as a result of comparing the highest probe similarity scores 213 to detect face morphing.

In an embodiment, with reference to FIG. 2 and FIG. 7, the process for detecting face morphing by one-to-many face recognition includes: producing a plurality of morph face images 206, wherein each morph face image 206 is produced from a pair of bona fide face images 207 in a plurality of bona fide face images 207; producing the gallery 202 comprising morph face images 206 and the bona fide face images 207; performing a primary one-to-many search for each morph face image 206 and for each bona fide face image 207 among the gallery 202; producing, from performing the primary one-to-many search, a plurality of primary candidate lists 210, such that a primary candidate list 210 is produced for every morph face image 206 and for every bona fide face image 207, each primary candidate list 210 comprising a plurality of primary similarity scores 211; selecting the highest primary similarity scores 212 from each primary candidate list 210; analyzing the highest primary similarity scores 212 between the morph face images 206 and the bona fide face images 207; and producing the morph decision boundary 205 between the highest primary similarity scores 212 for the morph face images 206 and the bona fide face images 207. In an embodiment, detecting face morphing by one-to-many face recognition includes curating the bona fide face images 207. In an embodiment, detecting face morphing by one-to-many face recognition includes rank ordering the primary similarity scores 211 for each of the primary candidate lists 210. In an embodiment, rank ordering provides for each primary candidate list 210: the primary similarity scores 211 ranked in sequential numerical ordering with the highest primary similarity scores 212 listed sequentially before other primary similarity scores 211, with the highest primary similarity score 211 listed first in the primary candidate list 210 at rank1, the second highest primary similarity score 211 listed second in the primary candidate list 210 at rank2, and the lowest primary similarity score 211 listed last in the primary candidate list 210. In an embodiment, highest primary similarity scores 212 are the rank1 primary similarity scores 211 and the rank2 primary similarity scores 211.

In an embodiment, with reference to FIG. 3, detecting face morphing by one-to-many face recognition includes validating the morph face images 206 prior to producing the gallery 202 from the morph face images 206 and the bona fide face images 207. In an embodiment, validating the morph face images 206 includes performing, for each morph face image 206, a one-to-one search that includes: performing individual comparisons by comparing the morph face image 206 individually with each bona fide face image 207 from the pair of bona fide face images 207 from which produced the morph face image 206, and producing a pair of validation similarity scores 214 from the individual comparisons; comparing the pair of validation similarity scores 214 to a threshold similarity score 215; adding the morph face images 206 to the gallery 202 when the pair of validation similarity scores 214 is greater than the threshold similarity score 215, and otherwise not adding the morph face images 206 to the gallery 202. In an embodiment, threshold similarity score 215 corresponds to a rate of false matching of less than or equal to 0.001. Other rate of false matching can be used depending on a desired sensitivity or application of the process for detecting face morphing by one-to-many face recognition.

In an embodiment, detecting face morphing by one-to-many face recognition includes rank ordering the probe similarity scores 204 for the probe candidate list 203 to provide the probe similarity scores 204 ranked in sequential numerical ordering with the highest probe similarity scores 213 listed sequentially before other highest probe similarity scores 213, with the highest probe similarity score 204 listed first in the probe candidate list 203 at rank1, the second highest probe similarity score 204 listed second in the probe candidate list 203 at rank2, and the lowest probe similarity score 204 listed last in the probe candidate list 203. In an embodiment, highest probe similarity scores 213 are the rank1 probe similarity scores 204 and the rank2 probe similarity scores 204.

In an embodiment, gallery 202 comprises a plurality of bona fide face images 207 and morph face images 206. In an embodiment, morph decision boundary 205 provides a partition between a bona fide image space 208 and a morph image space 209 for classifying the highest probe similarity scores 213.

In an embodiment, detecting face morphing by one-to-many face recognition includes a computer program comprising instructions that, when executed by one or more processors of a computing system, cause the computing system to perform a process such as one or more of the process described above or elsewhere herein.

In an embodiment, detecting face morphing by one-to-many face recognition includes one or more computing devices configured to perform a process such as one or more of the process described above or elsewhere herein.

Curating the set of bona fide face images 207 can include selecting candidate images with qualities that are representative of the data under which morph detection occurs, e.g., in passport application processing. Generating a set of morph face images 206 with morph creation software can occur by providing pairs of bona fide face images 207 as input. This can be accomplished by selecting pairs of people who share apparent similarities in gender, age, and race. With the generated morph face images 206 and the set of bona fide face images 207 used to generate morph face images 206, using a one-to-many face recognition algorithm to perform one-to-many search, each morph face image 206 and bona fide face image 207 is searched against an existing database (e.g., a gallery) that includes prior photo(s) of the people from the set of bona fide face images 207. For each morph face image 206 and bona fide face image 207 searched, the candidate list produced by the one-to-many face recognition search can be retrieved and subjected to obtaining the highest similarity scores returned (e.g., rank 1 and rank 2 similarity scores). The highest similarity scores produced by searching versus searching bona fide face images 207 can be analyzed to produce morph decision boundary 205 for morph detection. Such can be accomplished through visual inspection, training a morph classifier with similarity scores, and the like.

Bona fide face images 207 can be, e.g., portrait-style images of faces collected with a neutral expression, good illumination, and a plain background.

In producing the set morph face images 206, pairs of people who share selected similarities (e.g., gender, age, race, and the like) can be chosen for selective combination from bona fide face images 207. A configuration of morph creation software that produces morph face images 206 form pair-wise combination of a first bona fide face image 207 and a second bona fide face image 207 can provide an arbitrary contribution of each bona fide face image 207. In an embodiment, an equal contribution of each bona fide face image 207 (e.g., with blending and warping factors of 50% subject A and 50% subject B) is used to produce morph face image 206. Characteristics of a good face morpher include generation of morph face images 206 that produce high match scores when one-to-one face recognition is used to compare morph face image 206 against other photos of the subjects of bona fide face images 207 that were combined to produce morph face image 206 as well as good visual quality output, wherein little to no morphing artifacts are visible to the human eye.

Validating each morph face image 206 for its ability to pass one-to-one face recognition (also referred to as face matching, e.g., by analysis using a face matcher) can occur by using a one-to-one face recognition algorithm that takes two photos as input and generates a single similarity score as output. For each morph face image 206, a one-to-one face recognition comparison is made with morph face image 206 as a first input, and a photo of one of the subjects that contributed to producing morph face image 206 is a second input. This process is repeated for each subject that contributed to morph face image 206, for all morph face images 206. A one-to-one face recognition threshold similarity score 215 is set that corresponds to a desired false-match rate, e.g., 001 or lower. Morph face images 206 are retained where one-to-one face recognition comparisons with all contributing subjects produce validation similarity scores 214 that are greater than threshold similarity score 215 (i.e., morph face images 206 that were able to pass the face matcher). That is, morph face images 206 where comparisons produced validation similarity scores 214 greater than threshold similarity score 215 for the face matcher (i.e., morph face images 206 that are able to pass the face matcher) are used as input into the one-to-many face recognition search.

With generated morph face images 206 and the set of bona fide face images 207 used to generate morph face images 206, a one-to-many face recognition algorithm is used to search each image 206, 207) against an existing enrollment database that includes prior photo(s) of the people from the set of bona fide face images 207. Making the enrollment database includes enrolling photos of each of the subjects from bona fide face images 207 using the one-to-many face recognition algorithm. The set of enrollment photos should be different from the photos that are a part of the set bona fide face images 207. After the enrollment database is created, the one-to-many face recognition algorithm is used to search all morph face images 206 and bona fide face images 207 against the enrollment database.

For each image searched, the candidate list produced by the one-to-many face recognition search is retrieved and used to obtain the highest similarity scores returned (e.g., rank 1 and rank 2 similarity scores). For each image searched, the output from the one-to-many face recognition algorithm is a ranked candidate list with the most similar people found at the top of the list, along with their corresponding similarity scores.

The morph detection process provides automated face recognition to compare morph face image 206 with the subjects that contributed to morph face images 206, wherein the returned similarity score is generally lower than when two bona fide face images 207 of the same person are compared. This results occurs because morph face images 206 contain a reduced amount of identity information for each contributing subject. Depending on whether probe image 201 being searched is bona fide face image 207 or morph face image 206, differences can be observed in the highest similarity scores that are returned on the candidate list.

A search of bona fide face image 207 with a one-to-many face recognition algorithm is expected to retrieve one or more photos of the person in probe image 201 from the database with very high similarity scores at the top of the candidate list. In the case of probe image 201 being morph face image 206 of two people (i.e., subject A and subject B), if only one of the contributing subjects exists in gallery 202, prior photos of that subject are returned in the candidate list having similarity scores at rank 1 and rank 2 with high but reduced similarity scores. If both subjects exist in probe image 201, any combination of only subject A, only subject B, or a combination of subject A and B could be returned at rank 1 and rank 2, but with reduced similarity scores because morph face images 206 contain a reduced amount of identity information for each contributing subject, resulting in reduction in similarity scores.

Analyze the highest similarity scores produced by searching morph face images 206 versus searching bona fide face images 207 to generate morph decision boundary 205 for doing morph detection can be accomplished by visual inspection, training a morph classifier with the similarity scores, and the like.

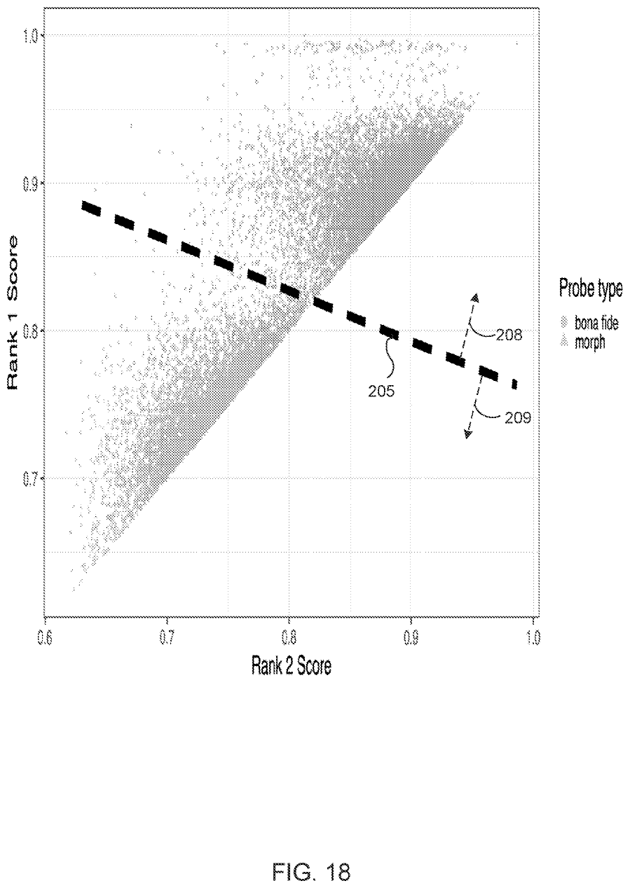

In an embodiment, with reference to FIG. 18, visual inspection is used to determine morph decision boundary 205. It should be appreciated that morph decision boundary 205 partitions pairs of rank 1 and rank 2 similarity scores from the space of all rank 1 and rank 2 similarity scores into bona fide image space 208 (for classification of a probe image as a bona fide image) and morph image space 209 (for classification of a probe image as a morph image). If rank 1 similarity scores and rank 2 similarity scores that correspond to bona fide face image 207 searches versus morph face image 206 searches are plotted as points on a scatterplot, larger separability between the clusters of bona fide scores and morph scores can be observed. The amount of separation will differ and vary across scores generated by different one-to-many face recognition algorithms, but morph detection accuracy (the amount of separation between scores) appears broadly correlated with general algorithm accuracy of the one-to-many face recognition algorithm being used. The more accurate the one-to-many face recognition algorithm and the more tolerant the algorithm is to aging effects between probe and gallery photos collected at different times, the more separability between bona fide scores vs. morph scores is observed, and hence, the higher morph detection accuracy will be using the invented method.

In an embodiment, one or more machine learning models are trained using instances of training data that are based on sets of pre-selected probe images 201. The instances of training data can be generated in order to capture training data that characterizes contexts for which similarity scores of highest rank (e.g., rank 1 and rank 2) from candidate lists produced by certain morph face images 206 or bona fide face images 207, e.g., as shown in FIG. 6. When the one or more trained machine learning models are trained according to these instances of training data, analysis of classification of probe image 201 as a bona fide face image 207 or morph face image 206 can be selectively optimized for sensitivity.

With reference to FIG. 6, machine learning can include a neural network (NN), e.g., an NN implementing machine learning, as an information processing paradigm that can include nodes, referred to as neurons, organized into layers, with links between the neurons. The links can transfer signals between neurons and can be associated with weights. A NN can be configured or trained for a specific task, e.g., pattern recognition or classification. Training a NN for the specific task can involve adjusting these weights based on examples. Each neuron of an intermediate or last layer may receive an input signal, e.g., a weighted sum of output signals from other neurons, and can process the input signal using a linear or nonlinear function (e.g., an activation function). The results of the input and intermediate layers can be transferred to other neurons, and the results of the output layer can be provided as the output of the NN. Typically, the neurons and links within a NN are represented by mathematical constructs, such as activation functions and matrices of data elements and weights. Processor 217, e.g. CPUs or graphics processing units (GPUs), or a dedicated hardware device can perform the relevant calculations.

As an application of machine learning to image processing to produce morph face image 206, one or more neural networks are configured to receive a first image, manipulate data pertaining to the first image, and produce from the manipulated data a second, manipulated image, e.g., morph face image 206. For example, a system for facial image manipulation can: (a) receive a first image depicting a first face; (b) use a first NN, referred to as an encoder, to encode the facial image into a low-dimension vector referred to as a latent vector, in a latent vector space; (c) modify the latent vector according to specific requirements; and (d) use a second neural network, referred to as a decoder, corresponding to the encoder, to decode the modified latent vector back to the image space, and thus produce a second, outcome facial image. A vector can be a list or ordered list of numbers or scalars, which may be indexed according to a specific order. The low-dimension vector can be referred to as latent in a sense that it can implement or represent a mapping of high dimensional data (e.g., the input image) to a lower dimensional data (e.g., the latent vector) with no prior convictions of how the mapping will be done and without applying manipulations to this mapping. A low dimensional vector or data structure may have less data or information than a high dimensional vector or data structure. In other words, the artificial NN may train itself for the best configuration, and the meaning or association of high dimensional data to low dimensional data may be hidden from a programmer or a designer of the NN. In a similar manner a NN can be used to produce a morph confidence score using rank 1 and rank 2 similarity scores, as indicated in FIG. 6.

In an embodiment, training a morph detector with similarity scores by machine learning is performed. Through visual inspection, appreciable separation is observed between the highest similarity scores (e.g., rank 1 and 2 scores) for bona fide searches versus morph searches from a gallery that contains prior photo(s) of the subject(s) in the probe. A morph detector can be created by training a neural network to determine morph decision boundary 205 for morph classification using the highest similarity scores. Rank 1 and rank 2 score pairs from bona fide searches and morph searches are fed into a simple neural network, e.g., as shown in FIG. 6. All scores are normalized using min-max normalization to adjust the data to a common scale between 0 and 1 prior to input into the network. The normalized similarity scores are provided as input into the neural network and the output is a morph confidence score, which can be compared against a predetermined threshold to determine whether the image might be a morph or not.

It should be appreciated that various facial recognition methods, including one-to-one (1:1) and 1:N (one-to-many) algorithms, and machine learning methods are known in the art, e.g., as disclosed in U.S. Pat. Nos. 9,959,455; 8,331,632; 9,830,506; 8,818,034; and 9,646,262, the disclosure of each of which is incorporated herein by reference in its entirety.

It is contemplated that and detecting face morphing by one-to-many face recognition can include the properties, functionality, hardware, and process steps described herein and embodied in any of the following non-exhaustive list:
a process (e.g., a computer-implemented method including various steps; or a method carried out by a computer including various steps);
an apparatus, device, or system (e.g., a data processing apparatus, device, or system including means for carrying out such various steps of the process; a data processing apparatus, device, or system including means for carrying out various steps; a data processing apparatus, device, or system including a processor adapted to or configured to perform such various steps of the process);
a computer program product (e.g., a computer program product including instructions which, when the program is executed by a computer, cause the computer to carry out such various steps of the process; a computer program product including instructions which, when the program is executed by a computer, cause the computer to carry out various steps);
computer-readable storage medium or data carrier (e.g., a computer-readable storage medium including instructions which, when executed by a computer, cause the computer to carry out such various steps of the process; a computer-readable storage medium including instructions which, when executed by a computer, cause the computer to carry out various steps; a computer-readable data carrier having stored thereon the computer program product; a data carrier signal carrying the computer program product);
a computer program product including comprising instructions which, when the program is executed by a first computer, cause the first computer to encode data by performing certain steps and to transmit the encoded data to a second computer; or
a computer program product including instructions which, when the program is executed by a second computer, cause the second computer to receive encoded data from a first computer and decode the received data by performing certain steps.

In an embodiment, with reference to FIG. 7, a computing device is included in a system for detecting face morphing by one-to-many face recognition. Computing device 216 can include a processor 217 that can be, e.g., a central processing unit (CPU) processor, a chip, or any suitable computing or computational device, operating system 218, memory 219, executable code 220, storage system 221, input device 222, and output device 223. Processor 217 (e.g., one or more controllers or processors, which can be distributed across a plurality of units or devices) can be configured to carry out processes described herein or configured to execute or act as the various modules, units, and the like. More than one computing device 216 can be included and one or more computing devices 216 can be the components of a system according to embodiments herein.

Operating system 218 can include a code segment (e.g., one similar to executable code 220 described herein) designed or configured to perform tasks involving coordination, scheduling, arbitration, supervising, controlling, or otherwise managing operation of computing device 216, e.g., scheduling execution of software programs or tasks or enabling software programs or other modules or units to communicate. Operating system 218 can be a commercial operating system. Operating system 218 can be an optional component, e.g., in some embodiments, a system can include computing device 216 that does not include operating system 218.

Memory 219 can include, e.g., a random access memory (RAM), a read only memory (ROM), a dynamic RAM (DRAM), a synchronous DRAM (SD-RAM), a double data rate (DDR) memory chip, a flash memory, a volatile memory, a non-volatile memory, a cache memory, a buffer, a short term memory unit, a long term memory unit, or other suitable memory units or storage units. Memory 219 can include a plurality of, possibly different, memory units. Memory 219 can be a computer or processor non-transitory readable medium or a computer non-transitory storage medium, e.g., a RAM. In an embodiment, a non-transitory storage medium such as memory 219, a hard disk drive, another storage device, and the like can store instructions or code which when executed by a processor may cause the processor to carry out processes described herein.

Executable code 220 can be any executable code, e.g., an application, a program, a process, task, script, and the like. Executable code 220 can be executed by processor 217 possibly under control of operating system 218. Executable code 220 can be an application that performs facial recognition described herein. Although, for the sake of clarity, a single item of executable code 220 is shown in FIG. 7, a system according to some embodiments can include a plurality of executable code segments similar to executable code 220 that can be loaded into memory 224 and cause processor 217 to carry out processes described herein.

Storage system 221 can include, e.g., a flash memory, a memory internal to or embedded in a micro controller or chip, a hard disk drive, a CD-Recordable (CD-R) drive, a Blu-ray disk (BD), a universal serial bus (USB) device, or other suitable removable or fixed storage unit. Data acquired by an edge device, that can include personal information such as an image depicting a person's face can be stored in storage system 221 and can be loaded from storage system 221 into memory 224 where the data can be processed by processor 217. In an embodiment, some of components shown in FIG. 7 can be absent. In an embodiment, memory 224 can be a non-volatile memory having the storage capacity of storage system 221. Accordingly, although shown as a separate component, storage system 221 can be included in memory 224.

Input device 222 can include any suitable input device, component, or system, e.g., a detachable keyboard, keypad, mouse, and the like. Output device 223 can include one or more (possibly detachable) displays or monitors, speakers, or other suitable output devices. Any applicable input/output (I/O) device can be connected to computing device 216 as shown by input device 222 and output device 223. In an embodiment, a wired or wireless network interface card (NIC), a universal serial bus (USB) device or external hard drive is included in input device 222 or output device 223. Any number of input devices 222 and output devices 223 can be operatively connected to computing device 216 as indicated by input device 222 or output device 223.

A system according to some embodiments can include components such as, but not limited to, a plurality of central processing units (CPU) or other suitable multi-purpose or specific processors or controllers (e.g., similar to processor 217), a plurality of input units, a plurality of output units, a plurality of memory units, and a plurality of storage units. It should be appreciated that a system for detecting face morphing by one-to-many face recognition, according to some embodiments, can be implemented as software modules, hardware modules, or any combination thereof. In an embodiment, the system includes a computing device such as computing device 216 and can be adapted to execute one or more modules of executable code (e.g., executable code 220) to perform detecting face morphing by one-to-many face recognition. In an embodiment, the system can include a first computing device 216 in communication with a second computing device 216.

Advantageously, detecting face morphing by one-to-many face recognition overcomes limitations and technical deficiencies of conventional devices and conventional processes and uses one-to-many (1:N) face recognition algorithms to detect the presence of face morphing in a probe image. Embodiments, analyzes the highest similarity scores that are returned from using a face recognition algorithm to search a photo against a database with prior photos of the claimed identity (e.g., during a passport renewal). As a novel departure from conventional morph detection techniques, detecting face morphing by one-to-many face recognition uses similarity scores from 1:N (one-to-many) face recognition algorithms for morph detection and produces morph detection rates at reduced false detection rates that are better than known conventional morph detection algorithms subjected to independent third-party tests. Beneficially, detecting face morphing by one-to-many face recognition can be used by face recognition providers and face recognition system owners to detect face morphing within their pipelines.

The articles and processes herein are illustrated further by the following Example, which is non-limiting.

### EXAMPLE

### NIST Face Recognition Vendor Test (FRVT). Part 4A: MORPH—Utility of 1:N Face Recognition for Morph Detection

Face morphing is an image manipulation technique where two or more subjects' faces are blended together to form a single face in a photograph [Reference 1]. Morphed photos often look realistically like all contributing subjects. Morphing is easy to do and requires little to no technical experience given the vast quantity of tools available at little or no cost on the internet and mobile platforms. If an attacker is able to submit a morphed photo which is accepted and placed onto an identity credential, multiple, if not all constituents of the morph can use the same identity credential, because modern face recognition will often erroneously authenticate the morph with the different contributing subjects. Morphs can be used to fool both humans [References 2, 3, 4]] and face recognition systems [Reference 5], which presents a vulnerability to current identity verification processes.

In the context of a potentially morphed image being used to apply for an identity credential, if the issuing organization maintains or has access to a centralized database of past applicant facial photos, there is an opportunity to search the application photo against the database with the goal of detecting morphs. We developed a methodology for doing morph detection using 1:N face recognition algorithms. Our approach analyzes the rank 1 and rank 2 scores that are returned on candidate lists from searching morph and bona fide photos against both consolidated and unconsolidated galleries of 1.6 million unique subjects under new enrollment and renewal scenarios. Morph classifiers are trained using the rank 1 and 2 score pairs from several modern 1:N face recognition algorithms and evaluated to quantify the utility of these scores in detecting morphs.

Morph detection using 1:N face recognition is promising in a renewal scenario. In a scenario where an identity credential is being renewed and there are multiple prior bona fide photos of the applicant in a database, the most accurate morph classifier successfully detected 83% of morphs at a threshold set to generate a false detection 1 out of every 1000 bona fide searches (BPCER=0.001). Setting a less restrictive threshold that generates a false detection 1 out of every 100 bona fide searches (BPCER=0.01), the morph classifier successfully detected morphs 98% of the time. See Part 6.5.3.

In a scenario where only a single bona fide photo of each subject is maintained in the database, the most accurate morph classifiers generated morph detection rates of 74% (BPCER=0.001) and 92% (BPCER=0.01) when both the ap-plicant and the “hidden identity” exist in the gallery. When only the applicant exists in the gallery, morph detection rates were 65% (BPCER=0.001) and 77% (BPCER=0.01). See Part 6.4.1.

Reduced false detection rates are attainable. While the prevalence of morphs in operations is not known, the assumption is that most operational transactions will be on legitimate photos that are not morphs. Therefore, it is important for morph detection technology to be able to operate at false detection rates low enough to support the level of resources available for secondary review, because any photo that is flagged as a morph will require additional resources to be adjudicated. Human review, investigation, and remediation of suspiciously flagged images can occur, and the investigation process may be non-trivial.

In a renewal scenario, for the most accurate morph classifiers tested in our study, morph detection rates at reduced false detection rates (i.e., BPCER=0.001) are better than many conventional differential morph detection algorithms evaluated in the FRVT MORPH activity that leverage an additional live image of the user or applicant to do morph detection. There can be errors associated with automated morph detection. The goal may be to establish thresholds such that false detection rates are at acceptable levels and even if morph detection rates are low, it would still yield gains in operations compared to not having any morph detection capability at all. See Parts 6.4.1 and 6.5.3.

Morph detection using 1:N face recognition is not effective in a new enrollment scenario. In a scenario where a person is applying for a new identity credential where no prior photos of the applicant exist in the database, morph detection rates were very low. In the best cases, only 0.2% of morphs were detected at a false detection rate of 0.001. See Part 7.3.

### Part 1 Face Morphing—an Attack on Identity Credentials

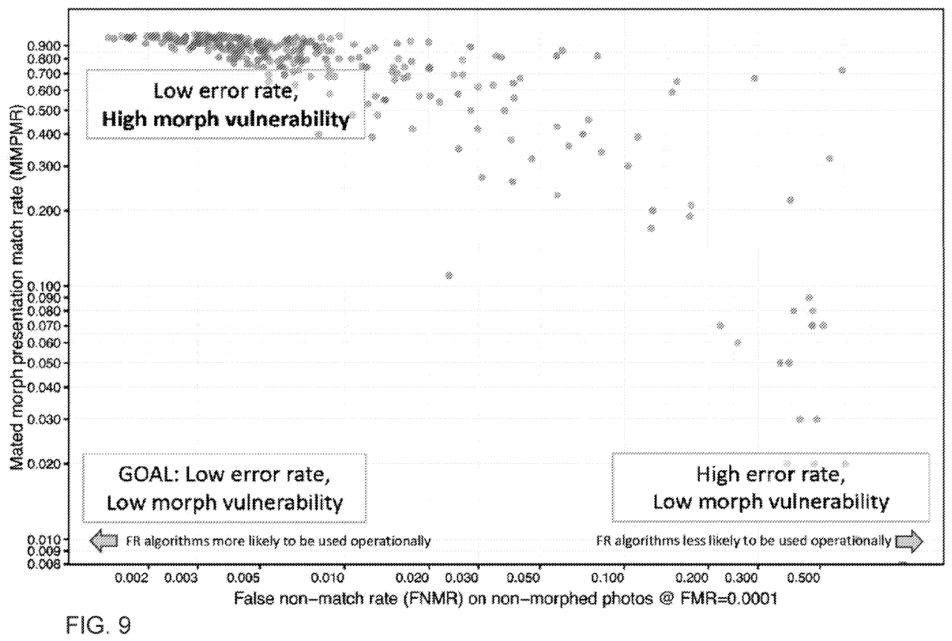

Face morphing is an image manipulation technique where two or more subjects' faces are blended together to form a single face in a photograph [Reference 1]. Morphed photos often look realistically like all contributing subjects. If an attacker is able to submit a morphed photo which is accepted and placed onto an identity credential, multiple, if not all constituents of the morph can use the same identity credential. Morphs can be used to fool both humans [References 2, 3, 4] and current face recognition systems [Reference 1], which presents a vulnerability to current identity verification processes. FIG. 9 illustrates the impact of morphed photos on conventional face recognition algorithms submitted to the NIST Ongoing FRVT 1:1 Verification test. The mated morph presentation match rate (MMPMR) [Reference 6] states how often both subjects erroneously authenticate against the morph and gives an indication of how vulnerable an algorithm is to morphs. The false non-match rate (FNMR) on non-morphed photos presents general face recognition accuracy.

The results in FIG. 9 show the more accurate face recognition algorithms tend to also be more vulnerable to morphing. The face recognition algorithms with low false non-match rates (FNMR::; 0.003) are also prone to match against two par-tial strength images from genuine subjects. While this is a desirable capability for authentic, bona fide natural images, it is a vulnerability when manipulated images may be submitted and image authenticity is in question. The high proportion of morph comparisons that would successfully authenticate at operationally realistic thresholds provides the basis and motivation for research into how to detect this form of image manipulation.

### Part 2 Methodology

### Part 2.1 Test Environment

The evaluation was conducted offline at a NIST facility by applying algorithms to still photos that is sequestered on computers controlled by NIST. Offline evaluations are attractive because they allow uniform, fair, repeatable, and large-scale statistically robust testing. However, they do not capture all aspects of an operational system. Offline tests do not include a live image acquisition component or any interaction with real users. Our approach is adopted to allow evaluation on large datasets and to achieve repeatability. Testing was performed on high-end server-class blades running the CentOS Linux [Reference 7] operating system. The test harness used concurrent processing to distribute workload across dozens of computers.

### Part 2.2 Algorithms

The eight one-to-many face recognition algorithms used in our investigation are competitive algorithms submitted to the NIST FRVT 1:N Identification Track in the late 2021/early 2022 timeframe. The algorithms all report non-zero similarity scores, with larger values indicating higher likelihood that two samples are from the same person. The range of the scores is not regulated and will vary between algorithms.

### Part 3 Image Datasets

### Part 3.1 Portrait Images

The images are all high-quality frontal portraits of adult subjects collected in immigration offices and with a white back-ground. As such, potential quality related drivers of high false match rates (such as blur) are expected to be absent. The images are collected in an attended interview setting using dedicated capture equipment and lighting. The images are of size 300×300 pixels, and the mean interocular distance of the subject in a photo is 61 pixels. The images are encoded as ISO/IEC 10918 i.e. JPEG. Over a random sample of 1000 images, the images have compressed file sizes (mean: 42 KB, median: 58 KB, 25-th percentile: 15 KB, and 75-th percentile: 66 KB). The implied bit-rates are mostly benign and superior to many e-Passports. Each image is accompanied by metadata, including subject age, sex, and place of birth.

### Part 3.2 Morphs

Morphed images were created from frontal portraits described in Part 3.1 using the University of Bologna's (UNIBO) v2.0 morphing tool [References 1,8-10] with two subjects. Subjects were demographically paired based on age (within one year), sex, and place of birth. The interior face regions from the two subjects were morphed with blending and warping factors of 0.50 (equal contributions from each subject to the morph), and one of the subjects provided the periphery (the head, hair, ears (if visible), body, and background). Using the methodology described above, an initial set of 40 79 9 morphs were generated from 81 598 unique subjects. All morphs were then validated for “usefulness” with several one-to-one face matchers submitted to the NIST FRVT 1:1 evaluation, where the morph was compared with other photos of both subjects. We set a score threshold that corresponds to a false match rate of 0.0 01 for each matcher. Morphs where comparisons generated scores that were above threshold for all matchers (i.e., morphs that were able to fool all matchers) were included in the dataset, and those that were below threshold were discarded. This resulted in 21 393 (52.4%) usable morphs in our dataset.

### Part 4 Metrics

Consistent with the FRVT MORPH [Reference 11] evaluation and the wider developer community [Reference 6], we adopt terminology from the presentation attack detection testing standard [Reference 12] to quantify morph classification accuracy, namely Attack Presenta-tion Classification Error Rate (APCER) and Bona Fide Presentation Classification Error Rate (BPCER). APCER is defined as the proportion of morph attack samples incorrectly classified as bona fide (nonmorph) presentation. Similarly, BPCER is defined as the proportion of bona fide (nonmorph) samples incorrectly classified as morphed samples.

### Part 4.1 Detection Error Tradeoff (DET)

We assess morph detection accuracy by analyzing the confidence score returned by the morph detection algorithm. In this case, the higher the confidence value, the more likely the algorithm thinks it is a morph. A reasonable approach to the detection problem is to classify an image as either a morph or bona fide image by thresholding on its confidence value.

Given N detection scores on bona fide images and detection score b, from the i-th bona fide image, where i=I . . . N, BPCER is computed as the proportion of bona fide scores above some threshold, T. Similarly, given M detection scores on morphed images and detection score m, from the i-th morphed image, where i=I . . . M, APCER is computed as the proportion of morphed scores below some threshold, T. H(x) is the unit step function [Reference 13], and H(0) is taken to be 1.

$$BPCER ( T ) = \frac{1}{N} {\sum }_{i = 1}^{N} H ( {b}_{i} - T ) , \qquad ( 1 )$$

$$APCER ( T ) = 1 - \frac{1}{M} {\sum }_{i = 1}^{M} H ( {m}_{i} - T ) . \qquad ( 2 )$$

### Part 5 1:N Search in Operational Scenarios

In the context of identity credentials with face portrait images, 1:N searches can be used for the purpose of detecting morphs. This assumes an issuing organization maintains or can access a database of past, trusted applicant face portraits, and there is a security requirement or reasonable basis to question the authenticity of newly submitted face images. 1:N searches for the purpose of morph detection should be done in conjunction with trained forensic human reviewers.

### Part 5.1 Enrollment Database Composition

In identity credentialing applications (e.g., passports, driver's licenses), collection and enrollment of biometric data from subjects often occur on more than one occasion. This might be done on a regular basis (once every 10 years for adult passports) or on an ad-hoc basis (re-issuance of a lost or stolen ID). Over time, images acquired during the ID re-issuance process are added to the database, and there are generally two approaches on handling multiple images collected of the same person.

Consolidated gallery (subject-based): Unique identities of people are maintained and a single representation of each subject exists in the database at any given time. New images acquired of a subject might be stored in a record that contains K 2:1 images of the subject, and it is up to the face recognition algorithm on how the subject representation is modeled internally. Or, depending on data retention policies, only the most recent photo of a subject is retained and all previously collected photos are discarded from the database. The experiments and results from Part 6 assume a consolidated gallery with a single representation of each unique subject.

Unconsolidated gallery (event-based): Here, images are added to the database without regard for whether the person already exists or not. Under this model, there can be multiple images of the same person in the gallery. Templates or representations are generated from single images independently and are treated as different identities. Administratively, there might be record-keeping that associates same-person images, but the underlying face recognition algorithm is not aware of this. The experiment and results from Part 6.5 assume an unconsolidated gallery with multiple photos of the same subject stored in the database.

### Part 5.2 Search Scenarios

We consider two operational scenarios for leveraging a 1:N search algorithm for morph detection, including
Renewal of an existing ID credential (Part 6)
   The application photo is a legitimate bona fide photo of the applicant, and prior bona fide photo(s) of the applicant exist in the database, or
   The application photo is a morphed photo of the applicant and a “hidden identity” and
      Prior bona fide photo(s) of the applicant exist in the database, or
      Prior bona fide photo(s) of both the applicant and the “hidden identity” exist in the database.
New enrollment/application for ID credential (Part 7)
   The application photo is a legitimate bona fide photo of the applicant, and there are no prior photos of the applicant in the database, or
   The application photo is a morphed photo of the applicant and a “hidden identity”, and no prior photo(s) of the contributing subjects exist in the database

### Part 6 Renewal of an Existing ID Credential

In a scenario where an applicant is renewing an existing ID credential, prior photo(s) of the applicant would exist in the database. We could reasonably expect that a 1:N search (with a modern face recognition algorithm) against a database of frontal, portrait photos to return the applicant at the top of the candidate list (i.e., at rank 1). For a mated search of a legitimate bona fide photo (which we expect will be the majority of transactions operationally), in addition to the applicant being returned at rank 1, we would also expect a very high similarity score to be associated with the match. In the case that the application photo is a morph and assuming only the applicant's photo(s) exist in the database, we expect the applicant to be returned at rank 1, but with a reduced similarity score. This is due to the fact that the morphed photo contains a reduced amount of the applicant's identity information (in our case, 50%). Now due to the fact that morphs contain identity information of two different people, it may be advantageous to also look at the rank 2 candidate that is returned. For simplicity in illustration, we assume a consolidated database where there's exactly one representation of each subject in the gallery and no threshold is set such that a search always returns the top K candidates. A discussion on morph detection on unconsolidated galleries is presented in Part 6.5.

### Part 6.1 Morph vs. Bona Fide Searches

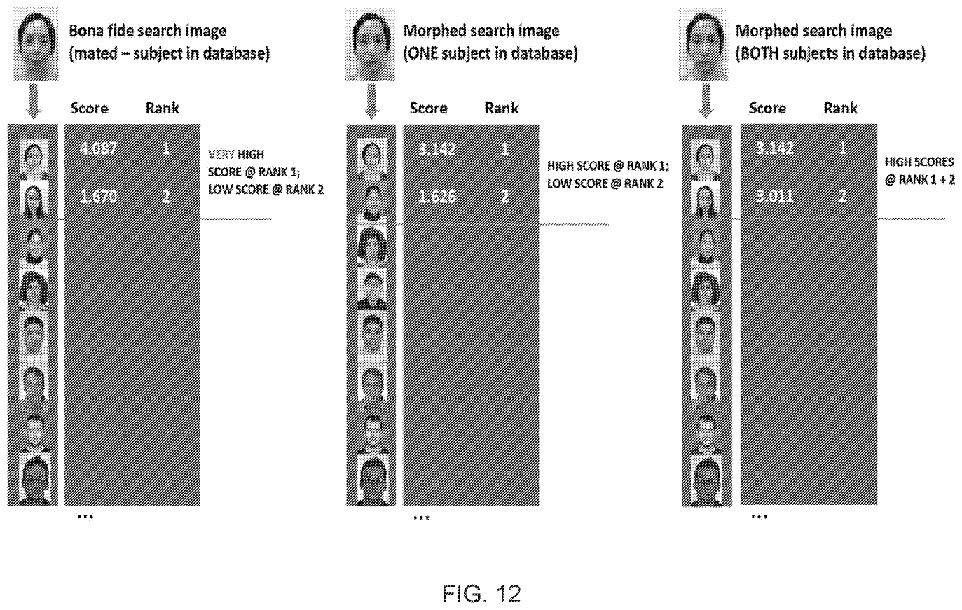

As illustrated in FIG. 12, a bona fide search would presumably retrieve the mate at rank 1 with a very high score, and a different person at rank 2 with a very low score. In the case that the probe is a morph, two scenarios could exist. First, if only the applicant exists in the gallery, then the mate at rank 1 would return a reduced but relatively high score and a different person at rank 2 with a very low score. If the probe is a morph and both subjects exist in the gallery, then we have a scenario where either subject could be retrieved at rank 1 with a reduced (but relatively high) score, and the subject at rank 2 would also match with a relatively high score due to the fact that the morph also contains identity information for that individual.

### Part 6.2 Experiment: Consolidated Gallery

We generated 21,393 morphs from 42,786 images of unique subjects using the methodology documented in Part 3.2. We then generated two different galleries—gallery 1 contains a prior photo of one of the subjects from any particular morph, and gallery 2 contains a prior photo of both of the subjects in the morph. Both galleries also include photos of other people to achieve a size of 1.6 million unique people. The 42,786 bona fides were searched against gallery 2, and the 21,393 morphs were searched against both gallery 1 and 2. We used eight state-of-the-art 1:N face recognition algorithms submitted to the NIST FRVT 1:N Identification Evaluation.

### Part 6.3 Analysis of Rank 1 and Rank 2 Scores: Consolidated Gallery

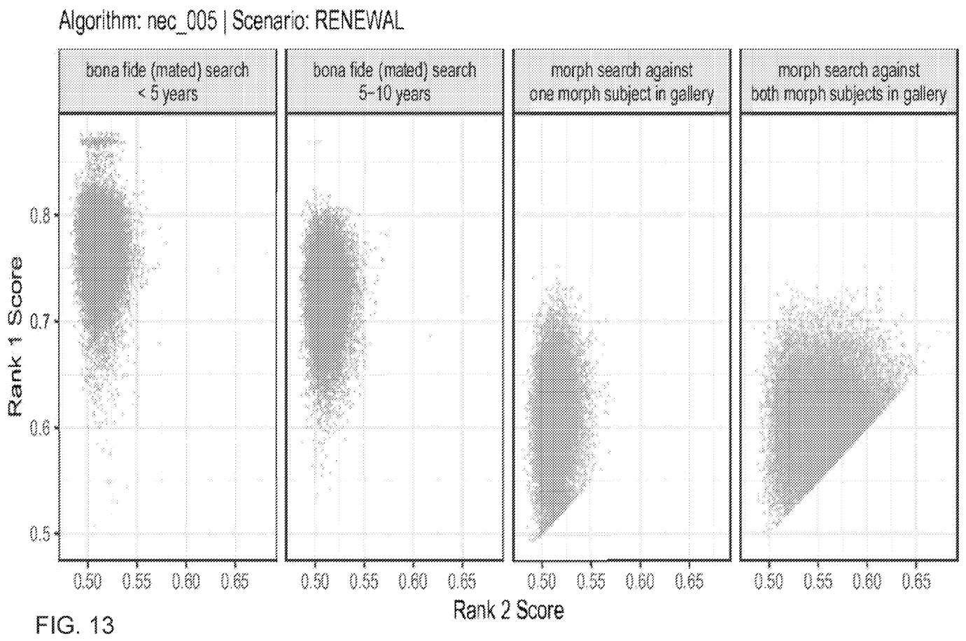

FIG. 13 shows the distribution of the algorithm's native rank 1 and rank 2 scores for each of the bona fide and morph search scenarios discussed. Additionally, the plot divides the bona fide search scores by searches where the probe and gallery images were collected less than 5 years apart and between 5 to 10 years apart. This gives an indication of how ageing may impact the rank 1 and 2 scores in our analysis of separability between bona fide and morph searches.

Consistent with our illustration from FIG. 12, we observe that mated bona fide searches where the probe and gallery images are less than 5 years apart consistently generate rank 1 scores that are generally higher than when the probe is a morph. But operationally, ID credentials such as passports or driver's licenses are typically renewed once every 5 to 10 years depending on the organization/country's renewal policy, which introduces a factor that must be accounted for, which is ageing. We do observe reduced rank 1 similarity scores from bona fide probes when the time elapsed between the probe and gallery images is between 5 to 10 years, which increases the overlap between bona fide and morph similarity scores. We observe reduced but relatively high rank 1 similarity scores for morph searches against a gallery containing just one of the contributing subjects and very low scores at rank 2. But morph searches when both contributing subjects exist in the gallery yield reduced (but relatively high) scores at both rank 1 and 2 due to the fact that the morph contains identity information for two individuals in the gallery. FIG. 13 presents score distributions for one algorithm. Results for a number of other 1:N algorithms we conducted this analysis on are presented in the Part 9.

### Part 6.4 Training a Morph Classifier

Through visual inspection, we can observe appreciable separation between the rank 1 and 2 scores for bona fide versus morph searches from a gallery that contains a prior photo of the subject(s) in the probe. To quantitatively express how useful these scores might be in detecting the presence of morphing, as a proof of concept, we trained a simple neural network to do morph classification using the rank 1 and 2 scores. For each 1:N algorithm used in our investigation, rank 1 and 2 score pairs from bona fide and morph searches are fed into a simple neural network (FIG. 6). All scores are normalized using min-max normalization (Equation 3) to adjust the data to a common scale between 0 and 1 prior to input into the network. This resulted in eight different morph classifiers created from the eight 1:N algorithm score pairs.

$${score}_{norm} = \frac{score - min ( rank 2 scores )}{max ( rank 1 scores ) - min ( rank 2 scores )} \qquad ( 3 )$$

We followed a 5-fold cross validation method where a random sample of 80% of the data (68,458 score pairs) is used for training, and the remaining 20% (17,114 score pairs) is used for testing, repeated over five iterations. The same exact par-titions of data were used to train and test each morph detector. This was accomplished by setting a different random seed in each iteration, then reusing the same seed to reproduce the random sampling of scores across the different algorithms.

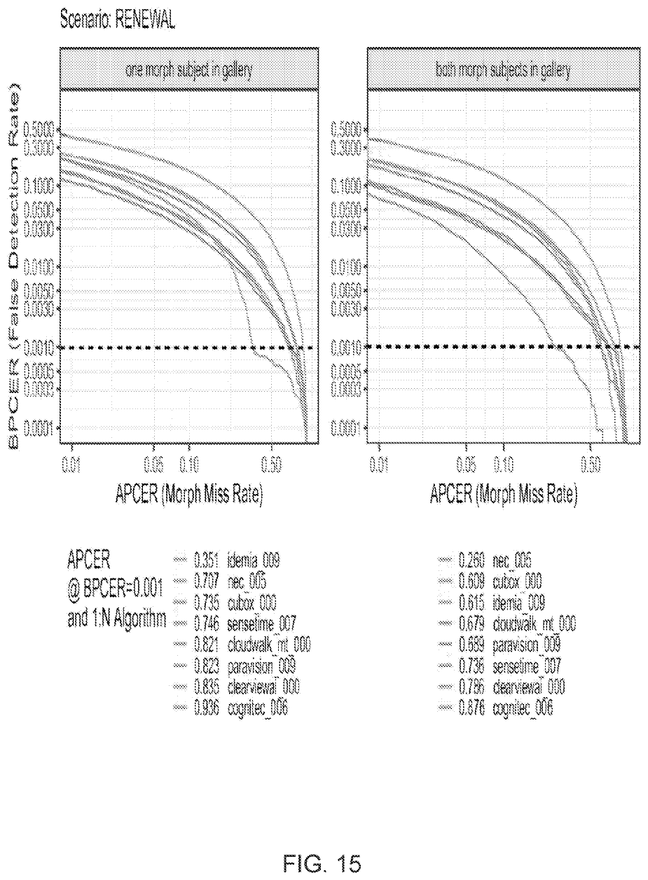

For testing, the inputs to the trained morph classifier are the normalized rank 1 and 2 score for a particular search, and the output is a confidence score between 0 and 1, with a score of 1 representing certainty that the score pairs correspond to a morph search, and 0 indicating certainty of a bona fide search. The 85,570 morph prediction scores (42,970 bona fide, 42,600 morph) across the five iterations of testing are used to measure classifier accuracy by plotting attack presentation classification error rate (APCER) or morph miss rate against bona fide classification error rate (BPCER) or false detection rate, as shown in FIG. 15.

### Part 6.4.1 Morph Detection Performance: Consolidated Gallery

From the results shown in FIG. 15, we observe that the rank 1 and 2 score pairs generated by 1:N algorithm searches of bona fide and morph probes appear to have utility in morph detection. In the best cases, we were able to train a morph classifier with the score pairs to detect morphs at performance levels that might be operationally useful. FIG. 15 decomposes the trained morph classifier accuracy by whether there is only one subject or both subjects in the gallery. For the most accurate 1:N algorithm when one subject exists in the gallery (idemia-009), its rank 1 and 2 score pairs generated a morph classifier where morph miss rate is 0.351 at a false detection rate of 0.001, meaning the classifier successfully detected 65% of morphs when the threshold is set to generate a false detection 1 out of every 1 000 bona fide searches. Reducing the threshold to produce a false detection rate of 0.01 (one false detection out of every 100 bona fide searches), the trained idemia-009 morph classifier would successfully detect morphs 77% of the time. For the most accurate algorithm when both subjects exist in the gallery (nec-005), the morph miss rate is 0.26 (74% of morphs successfully detected) at a false detection rate of 0.001, and relaxing the false detection rate to 0.01 would yield a morph miss rate of 0.08 (92% of morphs successfully detected).

We observe that there is a range of morph detection performance across the different 1:N algorithm scores that we trained on. Algorithms exhibit different levels of separability when it comes to the similarity scores it generates on morph versus bona fide searches, and morph detection performance appears broadly correlated with general algorithm accuracy. Many classifiers are able to detect morphs with lower error rates when both subjects exist in the gallery. This is likely due to the fact that there is larger separability between the bona fide and morph scores when both subjects are in the gallery, as visualized in FIG. 13. But operationally, the prior probability of whether only the applicant or the applicant and the “hidden identity” exist in the gallery is not well known. In the case of an ID renewal, the applicant will almost always exist in the gallery in order to pass typical identity confirmation checks, but whether the “hidden identity” will also exist in the gallery can depend on any number of factors.

### Part 6.4.2

In the experiment, as a proof of concept, we followed a 5-fold cross validation approach by splitting the rank 1 and 2 score pairs generated from the same “dataset” into randomly selected training and test sets, and repeated the process over five iterations. If the goal is to develop a generalizable morph detection algorithm that would work across different types of morphs (and bona fides), it would be due diligence to test and validate against different sets of score pairs generated using different types of morphs and bona fides and galleries composed of images of different qualities. For future work, NIST may assess the generalizability of using 1:N rank 1 and 2 score pairs for morph detection across different datasets and scenarios.

But, the initial goal of our investigation is primarily to present a methodology by which organizations might leverage a 1:N face recognition system in their operational pipeline to flag suspicious activity related to face morphing. Practically, an organization may only be concerned with their own data without needing to generalize, so training and testing with their own data would be a reasonable thing to do initially.

### Part 6.5 Consolidated vs. Unconsolidated Galleries

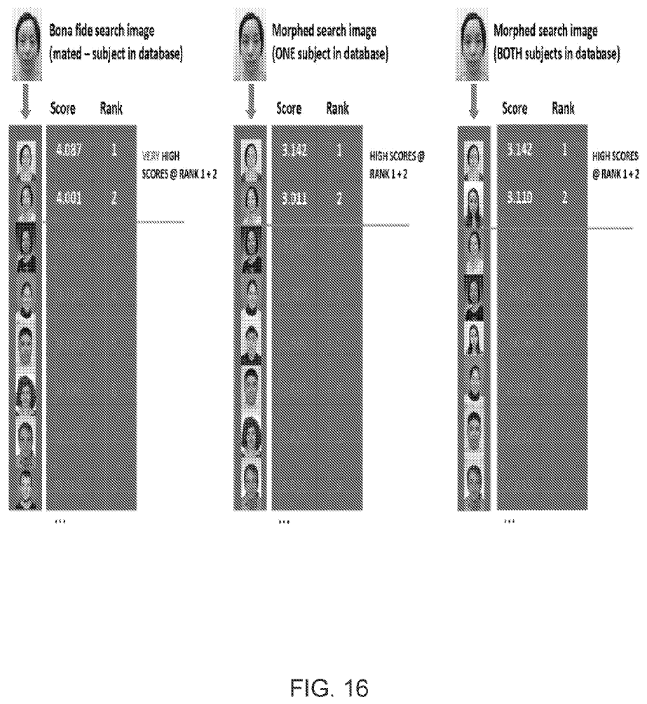

Whether a database is consolidated or unconsolidated will impact what gets returned on the candidate list. When a morph or bona fide probe is searched against an unconsolidated gallery under a renewal scenario, if multiple images of the subject(s) exist in the gallery, possible outcomes for what gets returned on the candidate list (see FIG. 16) include:
For a bona fide search, prior photos of the subject would be returned at rank 1 and 2 with very high similarity scores
For a morph search
   If only one of the contributing subjects exists in the gallery, prior photos of that subject would be returned at rank 1 and 2 with high but reduced similarity scores
   If both subjects exist in the gallery, any combination of subject A-only, subject-B only, or subject A and B could be returned at rank 1 and 2, but in all cases, with high but reduced similarity scores

If only a single image of the subject(s) exists in the gallery, the expected behavior would be the same as described in Part 6.1.

### Part 6.5.1 Experiment: Unconsolidated Gallery

A subset of the probes from Part 6.2 were used. Morphs and bona fides with two or more enrollment photos of each subject available were extracted from the probe set, and all corresponding enrollment photos were enrolled into each gallery. This resulted in 3,883 morphs and 7,808 bona fides that were searched against databases under the following scenarios: 1) bona fides were searched against a gallery where two or more prior photos of the subject exists, 2) morphs were searched against a gallery where two or more prior photos of one of the subjects in the morph exists, or 3) morphs were searched against a gallery where two or more prior photos of both subjects in the morph exist. All galleries contained one or more photos of 1.6 million unique subjects.

### Part 6.5.2 Analysis of Rank 1 and 2 Scores: Unconsolidated Gallery

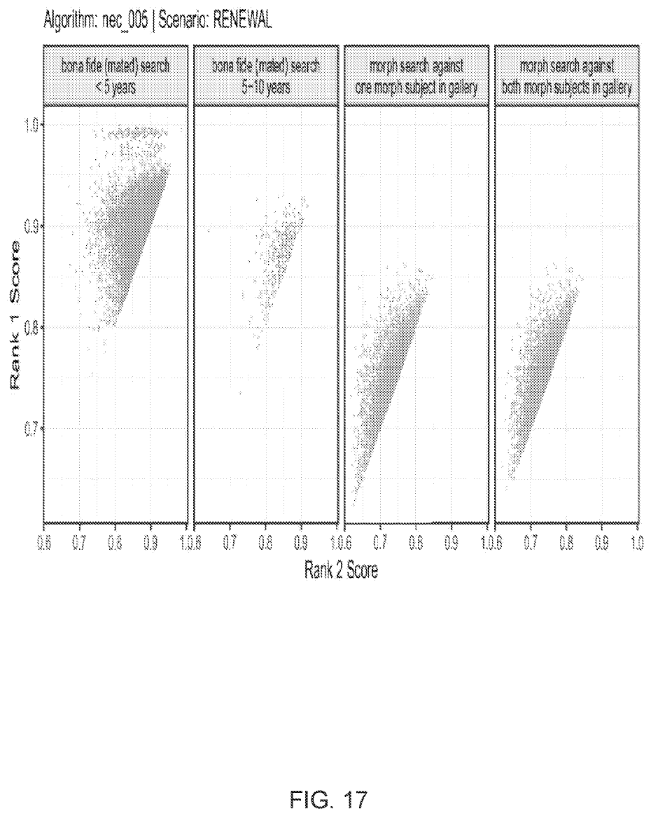

FIG. 17 shows the distribution of rank 1 and rank 2 scores when bona fide and morph probes are searched against unconsolidated galleries of different subject composition. Consistent with the results observed in Part 6.3, mated bona fide searches generate rank 1 scores that are often higher than when the probe is a morph. FIG. 17 presents score distributions for one algorithm. Results for a number of other 1:N algorithms we conducted this analysis on are presented in Part 9.

### Part 6.5.3 Morph Detection Performance: Unconsolidated Gallery

Rank 1 and 2 score pairs generated by the same 1:N algorithms from FIG. 15 were used to train and test morph classifiers under the scenario where the galleries are unconsolidated and contain multiple images of the same person. Following the same 5-fold cross validation training and testing methodology from Part 6.4, a random sample of 80% of the data (12460 score pairs) is used for training, and the remaining 20% (3,114 score pairs) is used for testing, repeated over five iterations. The 15,570 morph prediction scores (7,794 bona fide and 7,776 morph) across the five iterations of testing are used to measure classification accuracy.

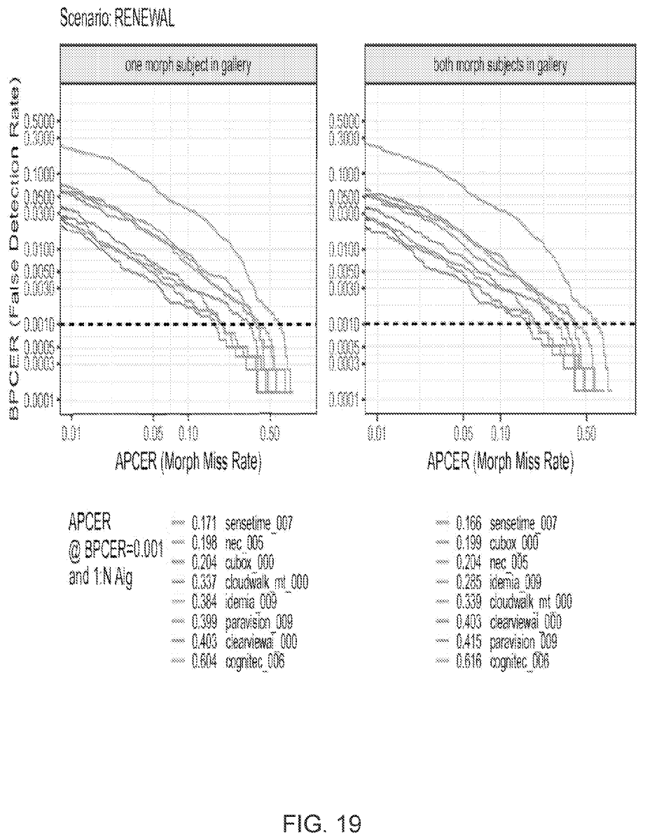

From the results shown in FIG. 19, we observe that the approach of using rank 1 and 2 score pairs for doing morph detection is often more effective when multiple images of the subject(s) exist in the gallery. A reduction in morph miss rates is observed when the morph classifiers are trained with scores from searching an unconsolidated database when compared to searching a consolidated database, and this trend is consistent across many of the algorithms that were tested. This is likely due to the fact that there is larger separability between the clusters of bona fide and morph scores when multiple images of the subject(s) are retrieved at rank 1 and 2, as visualized in FIG. 18.

For the most accurate 1:N algorithm under an unconsolidated gallery scenario (sensetime-007), at a false detection rate of 0.001, its rank 1 and 2 score pairs generated a morph classifier where morph miss rate is 0.171 and 0.166 when either one or both subjects exist in the gallery, respectively. This means the classifier successfully detected around 83% of morphs when the threshold is set to generate a false detection 1 out of every 1 000 bona fide searches. Relaxing the threshold where false detection rate is 0.01 (one false detection out of every 100 bona fide searches), the trained sensetime-007 morph classifier would successfully detect morphs approximately 98% of the time.

### Part 7 New Enrollment/Application for ID Credential

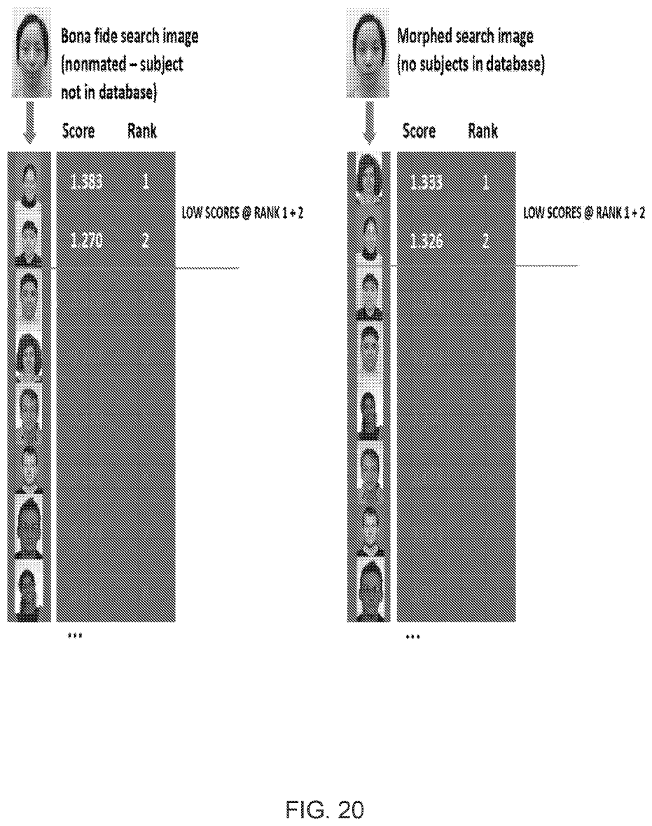

In a scenario where a person is applying for a new ID credential under an identity that presumably does not exist in the database, the expected outcome of a 1:N search of the application photo against the gallery would be the retrieval of very low similarity scores at rank 1 and 2 indicating that no existing matching identity was found. This behavior would be expected regardless of whether the photo is a bona fide or a morph, as illustrated in FIG. 20.

### Part 7.1 Experiment

Following the same experimental procedures from Part 6.2, the same set of 21,393 morphs and 42,786 bona fides were searched against a gallery where no prior enrollment of the subject(s) exists.

### Part 7.2 Analysis of Rank 1 and Rank 2 Scores

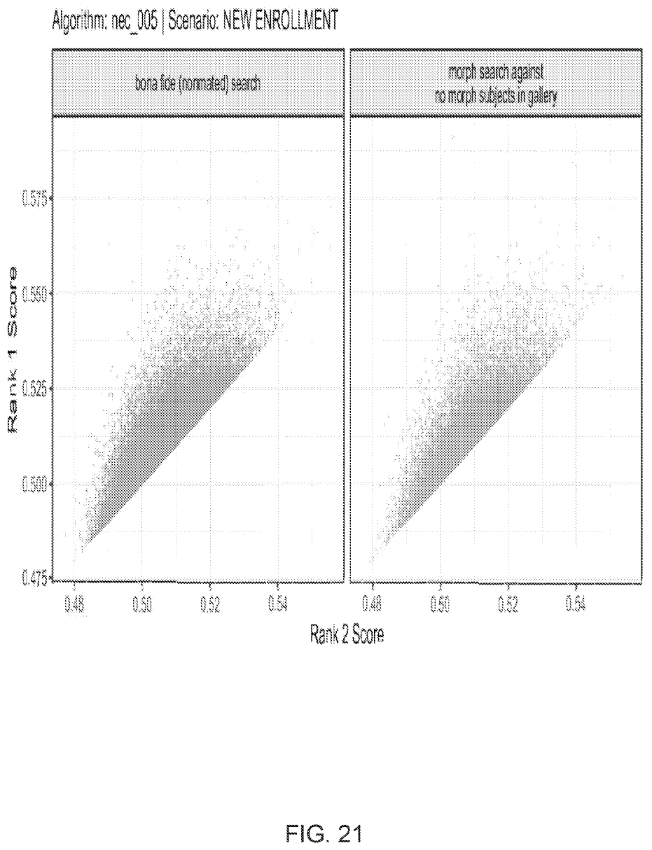

FIG. 21 shows the distribution of rank 1 and rank 2 scores when bona fide and morph probes are searched against a consolidated gallery where no prior photo of the subject(s) exists. Regardless of whether the probe is a bona fide or a morph, searches against a gallery where the applicant's identity does not exist generate very low scores at rank 1 and 2. FIG. 21 presents score distributions for one algorithm. Results for a number of other 1:N algorithms we conducted this analysis on are presented in Part 9.

### Part 7.3 Morph Detection Performance

Using the rank 1 and 2 scores generated from the scenarios in FIG. 21, we follow the same training and testing methodology from Part 6.4. Rank 1 and 2 score pairs and partitions generated by the same 1:N algorithms were used to train and test morph classifiers under the scenario where bona fides and morphs were searched against a gallery that did not contain the subject(s). Following the same 5-fold cross validation training and testing methodology, a random sample of 80% of the data (55,622 score pairs) is used for training, and the remaining 20% (12,836 score pairs) is used for testing, repeated over five iterations. The 64, 180 morph prediction scores (42,806 bona fide and 21,374 morph) across the five iterations of testing are used to measure classification accuracy.

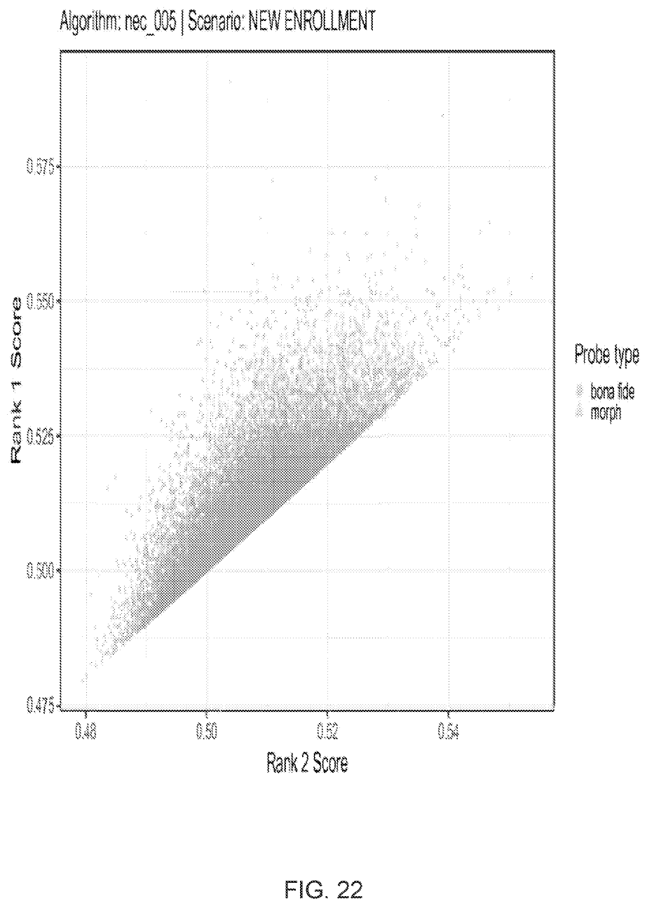

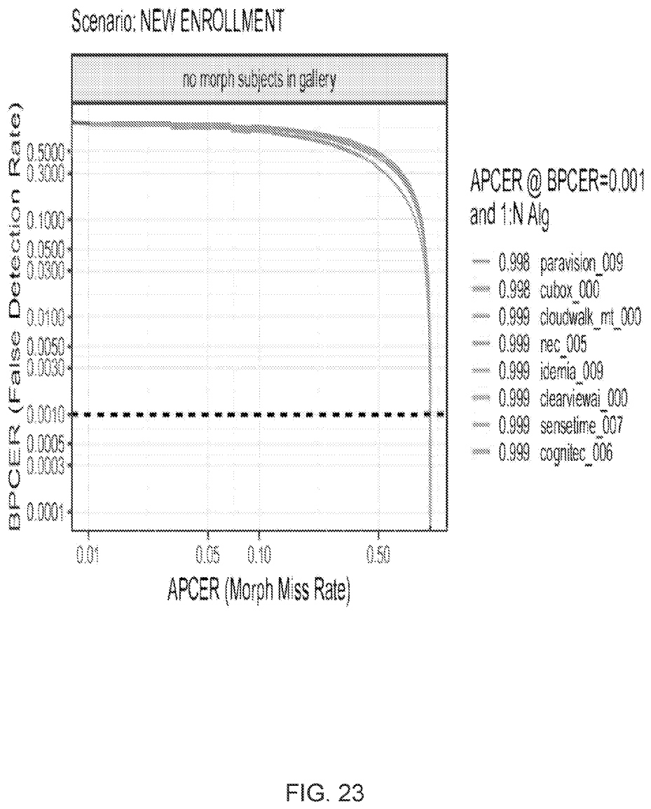

From the results shown in FIG. 23, we observe that the approach of using rank 1 and 2 score pairs for doing morph detection is not effective in a new enrollment scenario where the subjects in the morph have not been previously encoun-tered. The significant overlap between the bona fide and morph score distributions under this scenario, as visualized in FIG. 21 and FIG. 22, makes it difficult for the morph classifier to differentiate between a legitimate photo versus a morph.

### Part 8 Discussion

### Part 8.1 Utility of a 1:N Algorithm for Morph Detection in ID Renewal Processes

Based on the outcomes of the experiments discussed in this report, 1:N face recognition systems may have utility in detection of morphed photos in operational pipelines, with particularly promising results under an ID renewal scenario. One potential advantage of using this 1:N approach is that many ID issuance agencies (e.g., passport offices) will already have a 1:N face recognition system within their operational pipeline so there is opportunity to reuse existing infrastructure in lieu of procuring a dedicated morph detection capability.

At a high level, the following methodology for leveraging a 1:N face recognition algorithm for morph detection is:
Generate a set of morphs with relevant imagery, ideally operational data from the operational system (see Part 3.2).
Run searches with both morph and bona fide probes against the operational gallery (which contains existing photo(s) of the search subject(s)).
Conduct analysis of how your 1:N system behaves on morph vs. bona fide searches (our approach proposes analyz-ing rank 1 and 2 score pairs).
Identify potential thresholds for flagging suspicious activity based on trends observed between morph vs. bona fide score pairs. This might be accomplished through visual inspection, training a morph classifier with the score pairs, or some other approach.
Continuously and iteratively adjust thresholds/policies based on actual morph detection outcomes with human review and additional supporting information.

There will be errors associated with automated morph detection, and in our assessment of similarity scores as a potential way to classify morphs, it is possible for some legitimate mated bona fide searches to generate low similarity scores. The goal may be to establish thresholds such that false detection rates are at acceptable levels and even if morph detection rates are low, it would still yield gains in operations compared to not having any morph detection capability at all. We do not conceive of automated morph detection as being a lights-out operation, and there will almost always be human review, investigation, and remediation of suspiciously flagged images. The investigation process may not be trivial and may involve asking the applicant to conduct facilitated in-person photo recollection or some other process to reduce the opportunity for image manipulation.

### Part 9 Individual Algorithm Results

ID Renewal Scenario: The following plots show 1:N algorithm rank 1 and 2 similarity scores for bona fide or morph probes searched against a consolidated gallery, simulating possible scenarios for ID renewal:
The application photo is a legitimate bona fide photo of the applicant, and a prior photo of the applicant exists in the database
The application photo is a morphed photo of the applicant and a “hidden identity” and
   A prior photo of the applicant exists in the database
   A prior photo of both the applicant and the “hidden identity” exist in the

ID Renewal Scenario: The following plots show 1:N algorithm rank 1 and 2 similarity scores for bona fide or morph probes searched against an unconsolidated gallery that contains multiple (two or more) prior photos of the subject(s), simulating possible scenarios for ID renewal:
The application photo is a legitimate bona fide photo of the applicant, and multiple prior photos of the applicant exist in the database.
The application photo is a morphed photo of the applicant and a “hidden identity” and
   Multiple prior photos of the applicant exist in the database
   Multiple prior photos of both the applicant and the “hidden identity” exist in the database

New Enrollment/ID Application Scenario: The following plots show 1:N algorithm rank 1 and 2 similarity scores for bona fide or morph probes searched against a consolidated gallery, simulating possible scenarios of a new application for an ID credential:
The application photo is a legitimate bona fide photo of the applicant and no prior photo(s) of the applicant exist in the database
The application photo is a morphed photo of the applicant and a “hidden identity” and no prior photo(s) of the contributing subjects exist in the database

As referred to in the Example by bracketed numbers (“[Reference(s)*],” wherein “*” represents one ore more of the following numbered items), the following cited references are incorporated by reference herein in their entirety:
[Reference 1] M. Ferrara, A. Franco, and D. Maltoni. The magic passport. In IEEE International Joint Conference on Biometrics, pages 1-7, September 2014.
[Reference 2] Matteo Ferrara, Annalisa Franco, and Davide Maltoni. On the Effects of Image Alterations on Face Recognition Accuracy, pages 195-222. Springer International Publishing, Cham, 2016.
[Reference 3] David J. Robertson, Robin S. S. Kramer, and A. Mike Burton. Fraudulent id using face morphs: Experiments on human and automatic recognition. PLOS ONE, 12(3):1-12, 03 2017.
[Reference 4] Robin S. S. Kramer, Michael 0. Mireku, Tessa R. Flack, and Kay L. Ritchie. Face morphing attacks: Investigating detection with humans and computers. Cognitive Research: Principles and Implications, 4(1):28, 2019.
[Reference 5] Face Recognition Vendor Test (FRVT) MORPH Webpage. https://pages.nist.gov/frvt/reports/morph/frvt_morph_report.pdf.
[Reference 6] Ulrich Scherhag, Andreas Nautsch, Christian Rathgeb, Marta Gomez-Barrero, Raymond Veldhuis, Luuk Spreeuwers, Maikel Schils, Davide Maltoni, Patrick Crother, Sebastien Marcel, Ralph Breithaupt, R. Raghavendra, and Christoph Busch. Biometric systems under morphing attacks: Assessment of morphing techniques and vulnerability reporting. pages 1-7, 09 2017.
[Reference 7] The CentOS Project. https://www.centos.org.
[Reference 8] M. Ferrara, A. Franco, and D. Maltoni. Face demorphing. IEEE Transactions on Information Forensics and Security, 13(4):1008-1017 April 2018.
[Reference 9] Matteo Ferrara, Annalisa Franco, and Davide Maltoni. On the Effects of Image Alterations on Face Recognition Accuracy, pages 195-222. Springer International Publishing, Cham, 2016.
[Reference 10] M. Ferrara, A. Franco, and D. Maltoni. Decoupling texture blending and shape warping in face morphing. In Inter-national Conference of the Biometrics Special Interest Group (BIOSIG), pages 1-7, 2019.
[Reference 11] Mei Ngan, Patrick Crother, Kayee Hanaoka, and Jason Kuo. Face Recognition Vendor Test (FRVT) Part 4: MORPH—Performance of Automated Face Morph Detection, NISTIR 8292 Draft Supplement, April 2022. https://pages.nist.gov/frvt/reports/morph/frvt_morph_report.pdf.
[Reference 12] JTC 1/SC 37. International organization for standardization: Information technology biometric presentation attack detection part 3: Testing and reporting. In ISO/IEC 30107-3, 2017.
[Reference 13] E. J. Berg. Heaviside's operational calculus as applied to engineering and physics. Electrical engineering texts. McGraw-Hill book company, inc., 1936.
[Reference 14] P. Jonathon Phillips, Hyeonjoon Moon, Syed Rizvi, and Patrick Rauss. The feret evaluation methodology for face-recognition algorithms. Pattern Analysis and Machine Intelligence, IEEE Transactions on, 22:1090-1104, 10 2000.

The processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware, or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Any logical blocks, modules, and algorithm elements described or used in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described or used in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

What is claimed is:

1. A process implemented by one or more processors for detecting face morphing by one-to-many face recognition, the process comprising:
obtaining, by at least one processor of a computing device, a probe image;
performing, by the at least one processor, a probe one-to-many search for the probe image among a gallery;
producing, by the at least one processor, a probe candidate list from performing the probe one-to-many search for the probe image, the probe candidate list comprising a plurality of probe similarity scores;
comparing, by the at least one processor, the highest probe similarity scores of the probe candidate list to a morph decision boundary; and
determining, by the at least one processor, whether the probe image is a bona fide face image or a morph face image as a result of comparing the highest probe similarity scores to detect face morphing.

2. The process of claim 1, further comprising:
producing a plurality of morph face images, wherein each morph face image is produced from a pair of bona fide face images in a plurality of bona fide face images;
producing the gallery comprising morph face images and the bona fide face images;
performing a primary one-to-many search for each morph face image and for each bona fide face image among the gallery;
producing, from performing the primary one-to-many search, a plurality of primary candidate lists, such that a primary candidate list is produced for every morph face image and for every bona fide face image, each primary candidate list comprising a plurality of primary similarity scores;
selecting the highest primary similarity scores from each primary candidate list;
analyzing the highest primary similarity scores between the morph face images and the bona fide face images; and
producing the morph decision boundary between the highest primary similarity scores for the morph face images and the bona fide face images.

3. The process of claim 2, further comprising curating the bona fide face images.

4. The process of claim 2, further comprising rank ordering the primary similarity scores for each of the primary candidate lists.

5. The process of claim 4, wherein rank ordering recited in claim 4 provides for each primary candidate list:
the primary similarity scores ranked in sequential numerical ordering with the highest primary similarity scores listed sequentially before other primary similarity scores, with the highest primary similarity score listed first in the primary candidate list at rank1, the second highest primary similarity score listed second in the primary candidate list at rank2, and the lowest primary similarity score listed last in the primary candidate list.

6. The process of claim 5, wherein the highest primary similarity scores are the rank1 primary similarity scores and the rank2 primary similarity scores.

7. The process of claim 2, further comprising validating the morph face images prior to producing the gallery from the morph face images and the bona fide face images.

8. The process of claim 7, wherein validating the morph face images comprises performing, for each morph face image, a one-to-one search that comprises:
performing individual comparisons by comparing the morph face image individually with each bona fide face image from the pair of bona fide face images from which produced the morph face image as recited in claim 2, and producing a pair of validation similarity scores from the individual comparisons;
comparing the pair of validation similarity scores to a threshold similarity score;
adding the morph face images to the gallery when the pair of validation similarity scores is greater than the threshold similarity score, and otherwise not adding the morph face images to the gallery.

9. The process of claim 8, wherein the threshold similarity score corresponds to a rate of false matching of less than or equal to 0.001.

10. The process of claim 1, further comprising rank ordering the probe similarity scores for the probe candidate list to provide the probe similarity scores ranked in sequential numerical ordering with the highest probe similarity scores listed sequentially before other highest probe similarity scores, with the highest probe similarity score listed first in the probe candidate list at rank1, the second highest probe similarity score listed second in the probe candidate list at rank2, and the lowest probe similarity score listed last in the probe candidate list.

11. The process of claim 10, wherein the highest probe similarity scores are the rank1 probe similarity scores and the rank2 probe similarity scores.

12. The process of claim 1, wherein the gallery comprises a plurality of bona fide face images and morph face images.

13. The process of claim 1, wherein the morph decision boundary provides a partition between a bona fide image space and a morph image space for classifying the highest probe similarity scores.

14. A computer program comprising instructions that when executed by one or more processors of a computing system, cause the computing system to perform the process of any preceding claim.

15. One or more computing devices configured to perform the process of any one of claims 1 to 13.
